(19) United States
(12) Patent Application Publication
(10) Pub. No.: US 2026/0156698 A1
(43) Pub. Date: Jun. 4, 2026

(54) ELECTRONIC DEVICE, CONTROL METHOD, AND STORAGE MEDIUM STORING PROGRAM

(71) Applicant: CANON KABUSHIKI KAISHA, Tokyo (JP)

(72) Inventor: CHISEI SUMITA, Tokyo (JP)

(21) Appl. No.: 19/401,598

(22) Filed: Nov. 26, 2025

(30) Foreign Application Priority Data
Nov. 29, 2024 (JP) 2024-208887

(51) Int. Cl. H04W 76/14

(52) U.S. Cl. CPC H04W 76/14

(57) ABSTRACT

An electronic device includes: an acceptance unit that accepts a selection operation for selecting an operation mode from among a plurality of operation modes including a first operation mode for communication based on a Wi-Fi Direct R1 method and a second operation mode for communication based on a Wi-Fi Direct R2 method; and a communication unit that executes wireless communication between the electronic device and the external device using the operation mode selected via the selection operation, without involving an external access point different from the electronic device and different from the external device.

### BACKGROUND

### Field of the Technology

The present disclosure relates to an electronic device capable of wireless direct communication, a control method, and a storage medium storing a program.

### Description of the Related Art

In recent years, with increases in the amount of data communication, the development of communication techniques related to wireless local area network (LAN) and the like has been proceeding. The Institute of Electrical and Electronic Engineers (IEEE) 802.11 series of standards are known as the main standard for wireless LAN. The IEEE 802.11 series of standards include standards such as IEEE 802.11a/b/g/n/ac/ax, and the like. For example, the latest standard IEEE 802.11ax is a standard for techniques that use OFDMA to achieve a high peak throughput of up to 9.6 gigabits per second (Gbps) and improve the communication speed in a congested state. OFDMA is an abbreviation for orthogonal frequency-division multiple access.

Also, the Wi-Fi Alliance has established a program for authenticating wireless LAN devices. For example, in the established WFD standard, a procedure is defined for exchanging communication parameters between wireless LAN stations (STAs) and establishing a communication link between STAs without involving an access point (AP). WFD is an abbreviation for Wi-Fi Direct (registered trademark).

Also, the Wi-Fi Aware standard, which is a standard for searching for a service provided by an apparatus, has also been established. In Japanese Patent Laid-Open No. 2019-201427, detecting a communication terminal using the Wi-Fi Aware standard specifications is described. Also, in Japanese Patent Laid-Open No. 2013-157943, the matching of channels used for wireless infrastructure and wireless direct is described. In Japanese Patent Laid-Open No. 2023-115316, disabling wireless direct in a case where a specific frequency band has been used for wireless infrastructure is described.

### SUMMARY

The present disclosure provides an electronic device that improves the connectivity between devices via wireless direct, a control method, and a storage medium storing a program.

The present disclosure in one aspect provides an electronic device capable of communicating with an external device, the electronic device comprising: at least one memory and at least one processor which function as: an acceptance unit configured to accept a selection operation for selecting an operation mode from among a plurality of operation modes including a first operation mode for communication based on a Wi-Fi Direct R1 method and a second operation mode for communication based on a Wi-Fi Direct R2 method; and a communication unit configured to execute wireless communication between the electronic device and the external device using the operation mode selected via the selection operation, without involving an external access point different from the electronic device and different from the external device.

Features of the present disclosure will become apparent from the following description of embodiments with reference to the attached drawings. The following description of embodiments is given by way of example.

### BRIEF DESCRIPTION OF THE DRAWINGS

FIG. 1 is a diagram illustrating a system configuration.

FIGS. 2A and 2B are diagrams illustrating the configuration of a MFP.

FIGS. 3A to 3C are diagrams illustrating an operation display unit of a MFP.

FIGS. 4A and 4B are diagrams illustrating the configuration of a mobile terminal apparatus.

FIG. 5 is a diagram illustrating the configuration of an access point.

FIG. 6 is a sequence diagram for describing a WFD standard connection processing.

FIG. 7 is a sequence diagram for describing a WFD standard connection processing.

FIGS. 8A to 8M are diagrams illustrating user interface screens.

FIG. 9 is a flowchart illustrating the processing in the MFP.

FIG. 10 is a flowchart illustrating the processing in the MFP.

FIG. 11 is a flowchart illustrating the processing in the MFP.

FIG. 12 is a flowchart illustrating the processing in the MFP.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

There are a plurality of methods relating to the wireless direct predetermined standard, and some of these may not be compatible. In a case where the methods supported by an electronic device and an external device are different, the two devices may be unable to connect via wireless direct.

According to the present disclosure, connectivity between devices via wireless direct can be improved.

### System Configuration

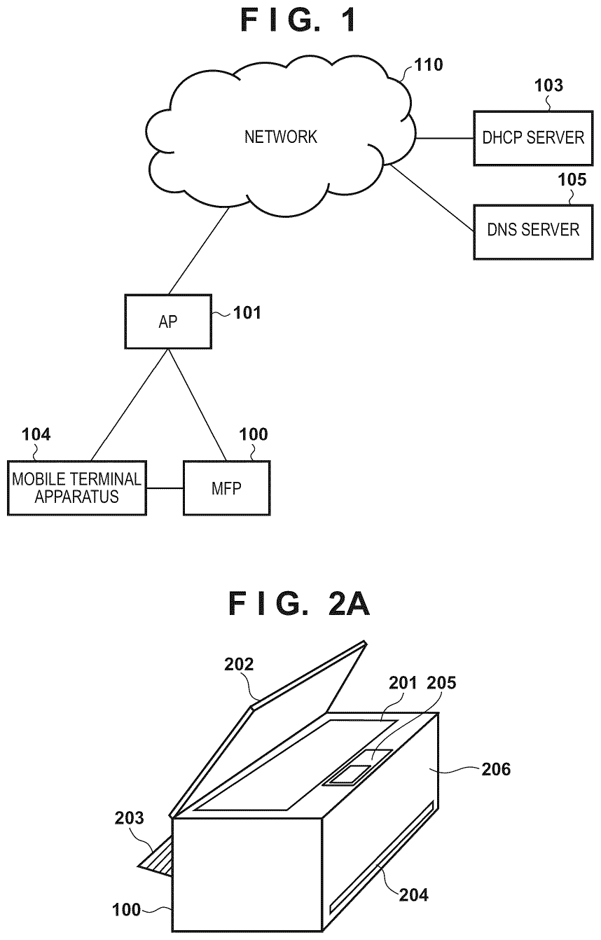

FIG. 1 is a diagram illustrating an example configuration of a system according to the present embodiment. The present system, in this example, is a wireless communication system enabling wireless communication between a plurality of communication apparatuses. In the example of FIG. 1, the communication apparatus includes a mobile terminal apparatus 104, an MFP 100, an access point AP 101, a DHCP server 103, a DNS server 105, and a network 110. The mobile terminal apparatus 104 is an apparatus with a wireless communication function such as wireless LAN. Note that hereinafter, wireless LAN may be referred to as WLAN. The mobile terminal apparatus 104 may be a personal digital assistant (PDA) or similar personal information terminal, a mobile phone (smartphone), a digital camera, a personal computer, or the like.

The MFP 100 is a printing apparatus with a print function and may also have a read function (scanner), a fax function, and a phone function. Also, the MFP 100 according to the present embodiment has a communication function enabling wireless communication with the mobile terminal apparatus 104. Also, in the present embodiment described herein, the MFP 100 is used as an example, but no such limitation is intended. For example, instead of the MFP 100, a scanner apparatus, a projector, a mobile terminal, a smartphone, a note PC, a tablet terminal, a PDA, a digital camera, a music playback device, a television, a smart speaker, or the like with a communication function may be used. Note that MFP is an acronym for multifunction peripheral.

The AP 101 operates as a WLAN base station apparatus provided seperately from (outside of) the mobile terminal apparatus 104 and the MFP 100. A communication apparatus with a WLAN communication function can communicate in WLAN infrastructure mode via the AP 101. Note that hereinafter, access point may be referred to as AP. Also, infrastructure mode may be referred to as wireless infrastructure mode. The AP 101 wirelessly communicates with a communication apparatus permitted (authenticated) to connect to it, and the communication apparatus relays wireless communication to other communication apparatuses. Also, the AP 101 may be connected to a wired communication network, for example, and relay communication between a communication apparatus connected to this wired communication network and other communication apparatuses wirelessly connected to the AP 101.

The DHCP server 103 is connected to the MFP 100 and the mobile terminal apparatus 104 via the AP 101 and the network 110 and provides a service by responding to a request from the MFP 100 or the mobile terminal apparatus 104. Note that the DHCP server 103 in FIG. 1 is illustrated as being connected to the AP 101 as a separated device. However, the AP 101 may have a DHCP server function. The DNS server 105 is connected to the MFP 100 and the mobile terminal apparatus 104 via the AP 101 and the network 110 and provides a service for name resolution by responding to a request from the MFP 100 or the mobile terminal apparatus 104. Here, the network 110 may be the so-called Internet, but a closed internal company network or a cellular network may be used.

### MFP External Appearance

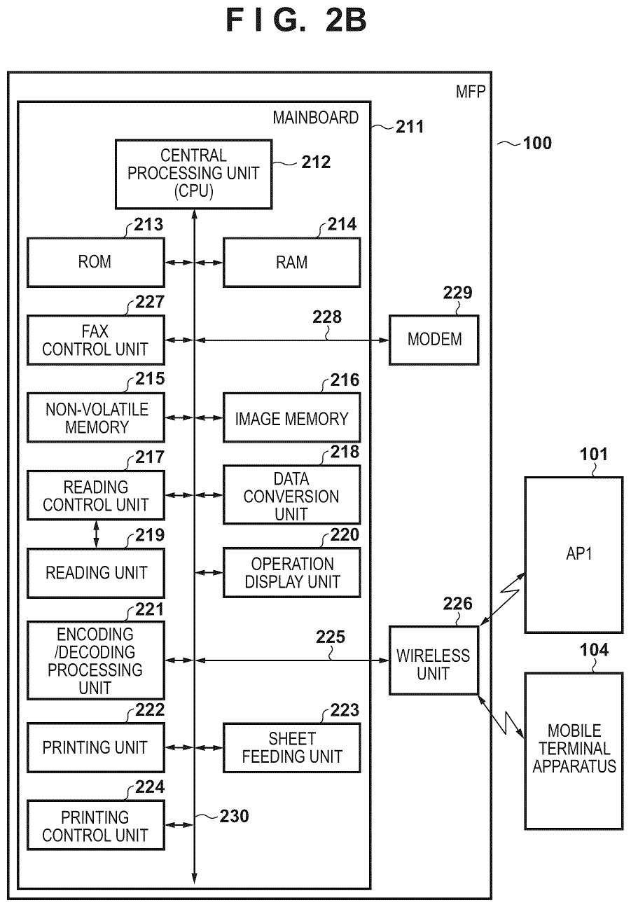

FIG. 2A illustrates an example of the external appearance of the MFP 100. The MFP 100 includes, for example, a platen 201, a document cover 202, a printing paper insertion opening 203, a printing paper discharge opening 204, and an operation display unit 205. The platen 201 is a platform for placing documents to be read. The document cover 202 is a cover used to press against a document placed on the platen 201 and prevent light from a light source illuminating the document escaping out during reading. The printing paper insertion opening 203 is an insertion opening where various sizes of sheets can be set. The printing paper discharge opening 204 is a discharge opening where sheets are discharged after printing. The sheets set in the printing paper insertion opening 203 are conveyed one sheet at a time to a printing unit and are discharged from the printing paper discharge opening 204 after printing has been performed by the printing unit. The operation display unit 205 includes character input keys, a cursor key, an enter key, a cancel key, and/or similar keys; LEDs; an LCD; and the like. The operation display unit 205 is configured to receive operations from the user relating to the activation of various types of functions of a MFP and various types of settings. Also, the operation display unit 205 may include a touch panel display. The MFP 100 has a WLAN wireless communication function and includes a wireless communication antenna 206 for wireless communication that is not necessarily visible from the outside. The MFP 100 can perform wireless communication via WLAN in a frequency range of the 2.4 GHz band, 5 GHz band, or 6 GHz band, for example, in a similar manner to the mobile terminal apparatus 104.

### MFP Configuration

FIG. 2B illustrates an example of the configuration of the MFP 100. The MFP 100 includes a mainboard 211 for performing main control of the apparatus itself and a wireless unit 226, which is a single communication module for performing WLAN communication using at least one shared antenna. Also, the MFP 100 includes a modem 229 for performing wired communication, for example. The mainboard 211 includes, for example, a central processing unit (CPU) 212, a ROM 213, a RAM 214, a non-volatile memory 215, an image memory 216, a reading control unit 217, a data conversion unit 218, a reading unit 219, and an encoding/decoding processing unit 221. Also, the mainboard 211 includes, for example, a printing unit 222, a sheet feeding unit 223, a print control unit 224, and an operation display unit 220. These functional units in the mainboard 211 are connected to one another via a system bus 230 managed by the CPU 212. Also, the mainboard 211 and the wireless unit 226 are connected via a dedicated bus 225, for example, and the mainboard 211 and the modem 229 are connected via a bus 228, for example.

The CPU 212 is a system control unit including at least one processor that controls the entire MFP 100. The processing of the MFP 100 described below is, for example, implemented by the CPU 212 executing programs stored in the ROM 213. Note that dedicated hardware may be prepared for each item of processing. ROM 213 stores control programs executed by the CPU 212, embedded OS programs, and the like. In the present embodiment, in a similar manner, the CPU 212 executes the control programs stored in the ROM 213 under the management of the embedded OS stored in the ROM 213 to perform software control such as scheduling and task switching.

The RAM 214 is constituted by an SRAM or the like. The RAM 214 stores data such as program control variables and the like, setting values registered by the user, MFP 100 management data, and the like. Also, the RAM 214 may be used as a buffer for various types of work. The non-volatile memory 215 is constituted by memory such as flash memory, for example, and continually stores data even after power to the MFP 100 is turned off. The image memory 216 is constituted by a memory such as a DRAM. The image memory 216 stores image data received via the wireless unit 226, image data processed by the encoding/decoding processing unit 221, and the like. Note that the memory configuration of the MFP 100 is not limited to the configuration described above. The data conversion unit 218 analyzes data of various formats, converts image data into print data, and the like.

The reading control unit 217 controls the reading unit 219 (for example, a contact image sensor (CIS)) to optically read the document placed on the platen 201. The reading control unit 217 converts the image obtained by optically reading the document into electrical image data (an image signal) for output. The reading control unit 217 may perform various types of processing such as binarization processing and halftone processing at this time and then output the image data.

The operation display unit 220 corresponds to the operation display unit 205 described with reference to FIG. 2A and displays to a display according to display control by the CPU 212 and generates signals in accordance with received user operations.

The encoding/decoding processing unit 221 performs encoding processing and decoding processing and enlargement and reduction processing of image data (JPEG, PNG, and the like) handled by the MFP 100.

The sheet feeding unit 223 holds sheets for printing. The sheet feeding unit 223 can supply sheets that have been set under the control of the print control unit 224. The sheet feeding unit 223 may include a plurality of sheet feeding units for holding a plurality of types of sheets in one apparatus and can control which sheet feeding unit to feed from under the control of the print control unit 224.

The print control unit 224 executes various types of processing such as smoothing processing, print density correction processing, and color correction on the image data to be printed and outputs post-processing image data to the printing unit 222. The printing unit 222 is configured to execute an inkjet printing process by discharging ink supplied from ink tanks from a print head and printing an image on a printing medium such as a sheet. Note that the printing unit 222 may be configured to execute an electro-photographic or other printing process. Also, the print control unit 224 may periodically read out information of the printing unit 222 and update status information such as ink tank remaining amount, print head state, and the like stored in the RAM 214.

The wireless unit 226 is a unit that can provide a WLAN communication function and, for example, can provide a function similar to a WLAN unit 429 of the mobile terminal apparatus 104. In other words, the wireless unit 226, following a WLAN protocol, converts data into packets and transmits packets to other devices or restores packets from other external devices into the original data and outputs them to the CPU 212. The wireless unit 226 can communicate as a station compliant with the IEEE 802.11 standard series. In particular, communication is possible as a station compliant with IEEE 802.11a/b/g/n/ac/ax. Hereinafter, station may be referred to as STA.

The wireless unit 226 supports IEEE 802.11ax, that is, Wi-Fi 6 (trademark) and can execute processing compliant with IEEE 802.11ax. In other words, the MFP 100 can process as a STA supporting (compliant with) OFDMA and/or can operate (process) as a STA supporting (compliant with) TWT. OFDMA is an abbreviation for orthogonal frequency-division multiple access. TWT is an abbreviation for target wake time. As TWT is supported, the data communication timing from the master unit to the STA is adjusted. The wireless unit 226, which is a STA, transitions the communication function to a sleep state when signal reception standby is not required. This can reduce power consumption. Also, the wireless unit 226 also supports Wi-Fi 6E (trademark). In other words, communication in the 6 GHz band (5.925 GHz to 7.125 GHz) can be performed. The target band for dynamic frequency selection (DFS) in the 5 GHz band is not in the 6 GHz band. Thus, with communication in the 6 GHz band, communication disconnections due to DFS standby time do not occur. Thus, better communication can be expected. Here, processing compliant with IEEE 802.11ax is executed. However, the mobile terminal apparatus 104 and the MFP 100 may operate in a manner compliant with another standard of the IEEE 802.11 series. For example, they may be compliant with standards subsequent to IEEE 802.11be.

Note that the mobile terminal apparatus 104 and the MFP 100 can perform P2P (WLAN) communication based on WFD, and the wireless unit 226 has a software access point (software AP) function or a group owner function. In other words, the wireless unit 226 can configure a P2P communication network, determine a channel to use for P2P communication, and the like. Here, WFD is based on a standard established by the Wi-Fi Alliance. Also, the wireless unit 226 can operate as a WFD client.

### MFP Operation Display Unit

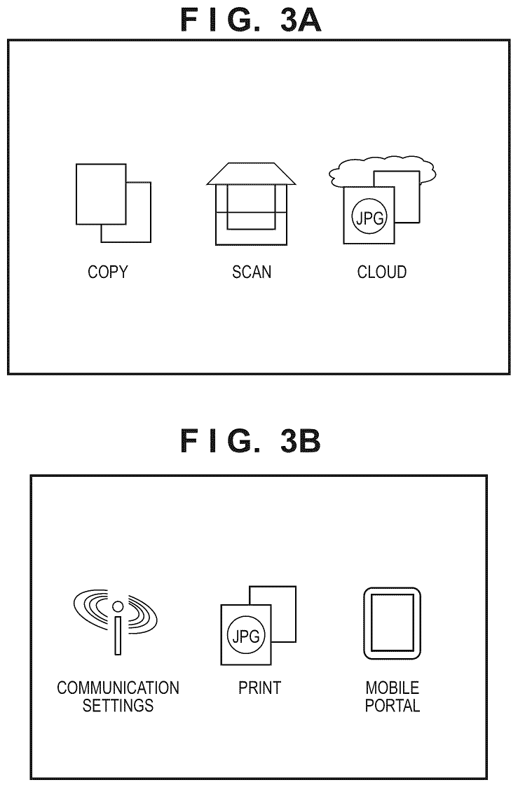

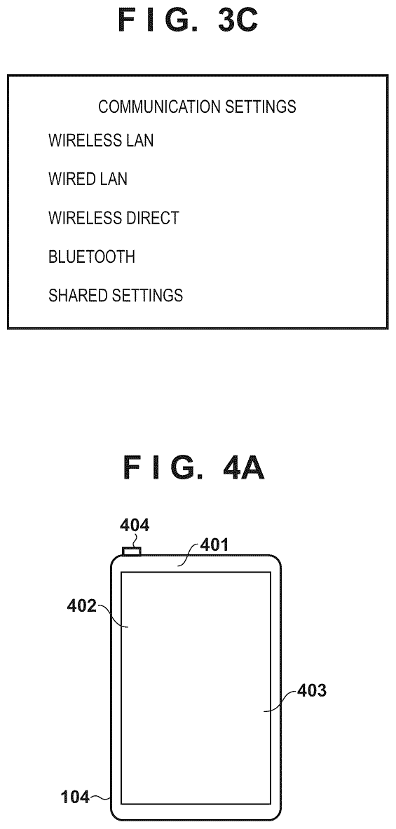

FIGS. 3A to 3C schematically illustrate example of a screen display on a display (touch panel display) including in the operation display unit 220 of the MFP 100. FIG. 3A is an example of a home screen displayed when the power of the MFP 100 is turned on and no operations such as printing or scanning are being performed (idle state, standby state). In FIG. 3A, display items (menu items) corresponding to copy, scan, and cloud are displayed. When one of the menu items is selected via operation of a key or the touch panel, the MFP 100 may start executing the corresponding setting or function. The MFP 100 can seamlessly display a screen different from that of FIG. 3A when a key or touch panel operation on the home screen of FIG. 3A is received.

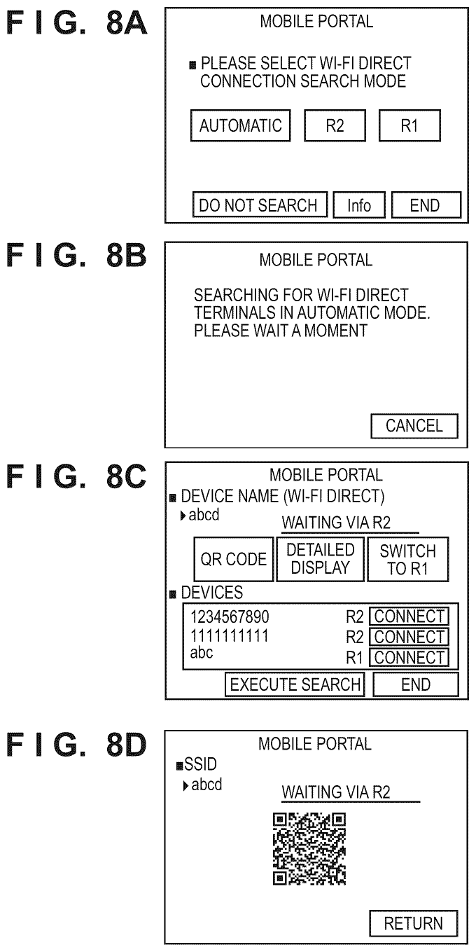

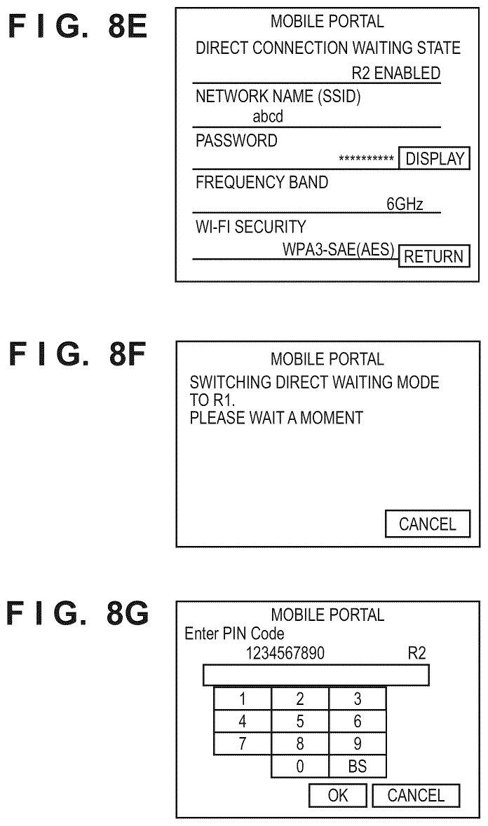

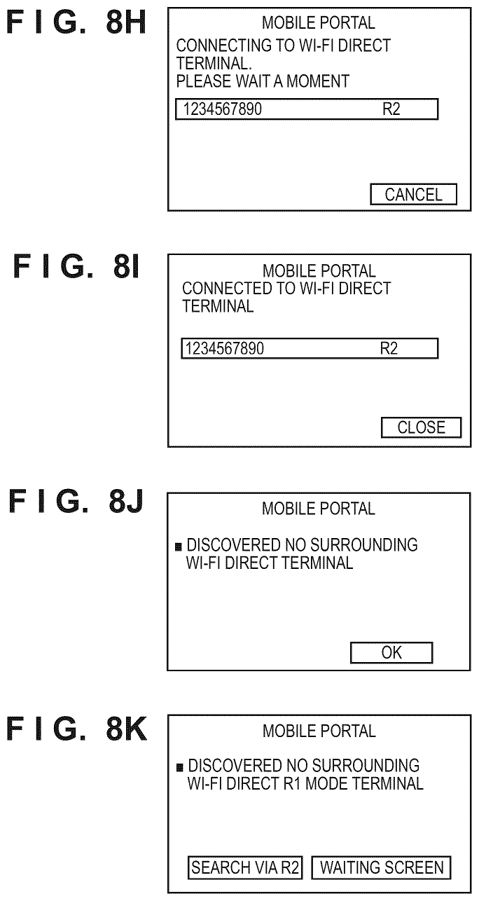

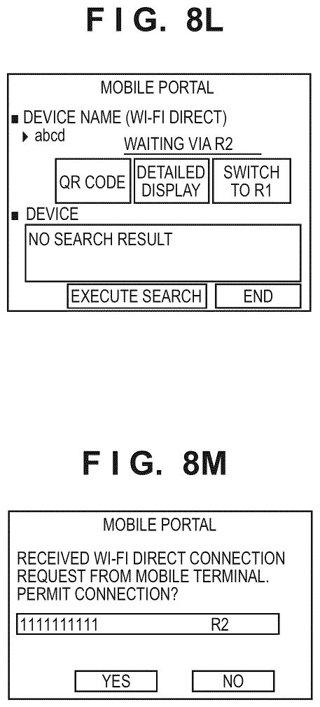

FIG. 3B is an example of a display of another part of the home screen and is a screen transitioned to from the state of FIG. 3A via an operation (left or right slide operation or the like) to display another page of the home screen. In FIG. 3B, display items (menu items) corresponding to communication settings, print, and mobile portal are displayed. A mobile portal is a menu item relating to a mobile portal function for communicating with a mobile device. A mobile device is, for example, the mobile terminal apparatus 104. When one of the menu items is selected via operation of a key or the touch panel, the MFP 100 may start executing the corresponding setting or function. When one of these menu items is selected, the function corresponding to the selected menu item is executed. A display example of a screen displayed in a case where mobile portal is selected on the screen of FIG. 3B will be described below using FIG. 8.

FIG. 3C is an example of a display of a menu screen for communication settings displayed when communication settings is selected on the screen of FIG. 3B. The menu screen for communication settings is a network settings screen displaying “Wireless LAN”, “Wired LAN”, “Wireless Direct”, “Bluetooth”, and “Shared Settings” as menu items (options). “Wireless LAN”, “Wired LAN”, and “Wireless Direct” are menu items for LAN settings, and from these items, wired connection settings, wireless infrastructure mode enabled/disabled setting, WFD, SoftAP mode, or similar wireless direct mode (P2P (WLAN) mode) enabled/disabled setting, and the like can be set. When the “Wireless LAN” item is selected and wireless LAN is set to on by a user operation, the wireless infrastructure mode is turned on. When the “Wireless direct” item is selected and wireless direct is set to on by a user operation, the P2P (WLAN) mode is turned on. On this screen, a shared settings menu relating to each connection state is also displayed. Also, the user can set the wireless LAN frequency range and frequency channel and the like from this screen.

### Mobile Terminal Apparatus External Appearance

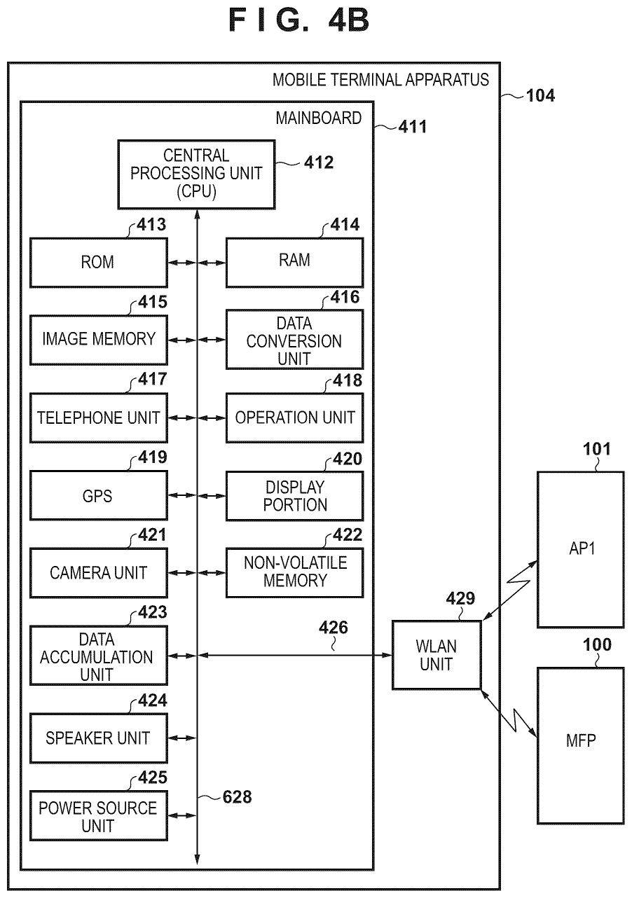

FIG. 4A is a diagram illustrating an example of the external appearance configuration of the mobile terminal apparatus 104. In the present embodiment, in this example, the mobile terminal apparatus 104 is a typical type of smartphone. Note that the mobile terminal apparatus 104, for example, includes a display portion 402, an operation portion 403, and a power key 404. The display portion 402 is a display including a liquid crystal display (LCD) display mechanism, for example. Note that the display portion 402 may display information using a light-emitting diode (LED), for example. Also, the mobile terminal apparatus 104 may have a function of outputting information via audio in addition to or instead of the display portion 402. The operation portion 403 includes physical keys such as keys and buttons, a touch panel, and the like for detecting a user operation. Note that in the present example, since displaying information on the display portion 402 and receiving user operation via the operation portion 403 is performed using a common touch panel display, the display portion 402 and the operation portion 403 are implemented using a single apparatus. In this case, for example, button icons and a software keyboard are displayed using a display function via the display portion 402, and the user touching these sections is detected by an operation reception function via the operation portion 403. Note that the display portion 402 and the operation portion 403 may be separated, and a piece of hardware for display and a piece of hardware for operation reception may be individually prepared. The power key 404 is a physical key for receiving a user operation for turning the power of the mobile terminal apparatus 104 on or off.

The mobile terminal apparatus 104 includes a WLAN unit 401 that provides a WLAN communication function and is not necessarily visible from the outside. The WLAN unit 401 is configured to execute data (packet) communication in a WLAN system compliant with the IEEE 802.11 standard series (IEEE 802.11a/b/g/n/ac/ax and the like), for example. Also, communication is possible as an AP supporting Wi-Fi Agile Multiband (trademark). However, no such limitation is intended, and the WLAN unit 401 may be configured to execute WLAN communication compliant with another standard. Note that in this example, the WLAN unit 401 can communicate on a 2.4 GHz, 5 GHz, or 6 GHz frequency band channel, for example. Also, the WLAN unit 401 can execute communication based on wireless direct mode, that is, communication based on WFD and communication using a SoftAP mode, communication using a wireless infrastructure mode, and the like. Operations in these modes will be described below.

### Mobile Terminal Apparatus Configuration

FIG. 4B illustrates an example of the configuration of the mobile terminal apparatus 104. The mobile terminal apparatus 104 in this example includes a mainboard 411 for executing main control of the apparatus itself and the WLAN unit 429 for WLAN communication. The mainboard 411 includes, for example, a CPU 412, a ROM 413, a RAM 414, an image memory 415, a data conversion unit 416, a telephone unit 417, a GPS 419, a camera unit 421, a non-volatile memory 422, a data accumulation unit 423, a speaker unit 424, and a power source unit 425. Here, CPU is an acronym for central processing unit, ROM is an acronym for read only memory, RAM is an acronym for random access memory, and GPS is an acronym for global positioning system. The mobile terminal apparatus 104 also includes a display unit 420 and an operation unit 418. Each functional unit in the mainboard 411 is connected to one another via a system bus 628 managed by the CPU 412. Also, the mainboard 411 and the WLAN unit 429 (the WLAN unit 401 described above) are connected via a dedicated bus 426, for example.

The CPU 412 is a system control unit including at least one processor that controls the entire mobile terminal apparatus 104. The processing of the mobile terminal apparatus 104 described below is, for example, implemented by the CPU 412 executing programs stored in the ROM 413. Note that dedicated hardware may be prepared for each item of processing. The ROM 413 stores a control program executed by the CPU 412, an embedded operating system (OS) program, and the like. In the present embodiment, in a similar manner, the CPU 412 executes the control programs stored in the ROM 413 under the management of the embedded OS stored in the ROM 413 to perform software control such as scheduling and task switching.

The RAM 414 is constituted by a Static RAM (SRAM) or the like. The RAM 414 stores data such as program control variables and the like, setting values registered by the user, mobile terminal apparatus 104 management data, and the like. Also, the RAM 414 may be used as a buffer for various types of work. The image memory 415 is constituted by a memory such as a Dynamic RAM (DRAM). The image memory 415 temporarily stores image data received via the WLAN unit 429 and image data read out from the data accumulation unit 423 for processing by the CPU 412. The non-volatile memory 422 is constituted by memory such as flash memory, for example, and continually stores data even after power to the mobile terminal apparatus 104 is turned off. Note that the memory configuration of the mobile terminal apparatus 104 is not limited to the configuration described above. For example, the image memory 415 and the RAM 414 may be shared, and data backup and the like may be performed using the data accumulation unit 423. Also, in the present embodiment, DRAM was given as an example of the image memory 415. However, another storage medium such as a hard disk or a non-volatile memory may be used.

The data conversion unit 416 executes analysis of data of various formats and data conversion, such as color conversion and image conversion. The telephone unit 417 performs control of a telephone line and implements telephone communication by processing audio data input/output via the speaker unit 424. The GPS 419 receives radio waves sent from satellites and obtains position information, for example the current latitude and longitude of the mobile terminal apparatus 104.

The camera unit 421 has a function of electronically recording and encoding an image input via a lens. The image data obtained via image capture by the camera unit 421 is stored in the data accumulation unit 423. The speaker unit 424 performs control to implement a function of inputting or outputting audio for the telephone function, as well as an alarm notification and the like. The power source unit 425 is a portable battery that controls power supply to the apparatus, for example. Power source states include, for example, a battery dead state in which the battery has no remaining amount, a power-off state in which the power key 404 is not pressed, an active state in which the apparatus is normally active, and a power saving state in which the apparatus is active but is set in a power saving mode.

The display unit 420 corresponds to the display portion 402 described with reference to FIG. 4A and displays various types of input operations, the operation situation of the MFP 100, status situations, and the like on the basis of control by the CPU 412. The operation unit 418 corresponds to the operation portion 403 described with reference to FIG. 4A and performs control including generating an electrical signal corresponding to a received user operation and outputting the electrical signal to the CPU 412.

The mobile terminal apparatus 104 can perform wireless communication using the WLAN unit 429 and communicate data with another device such as the MFP 100. The WLAN unit 429 converts the data into packets and transmits the packets to the other device. Also, the WLAN unit 429 restores a packet from an external other device into the original data and outputs this to the CPU 412. The WLAN unit 429 is a unit for implementing communication compliant with the WLAN standards. The WLAN unit 429 can operate in at least two communication modes in parallel, the at least two communication modes including wireless infrastructure mode and wireless direct mode (P2P (WLAN) mode). Note that the frequency range used in these communication modes may be restricted by the functions and performance of the hardware.

### Access Point Configuration

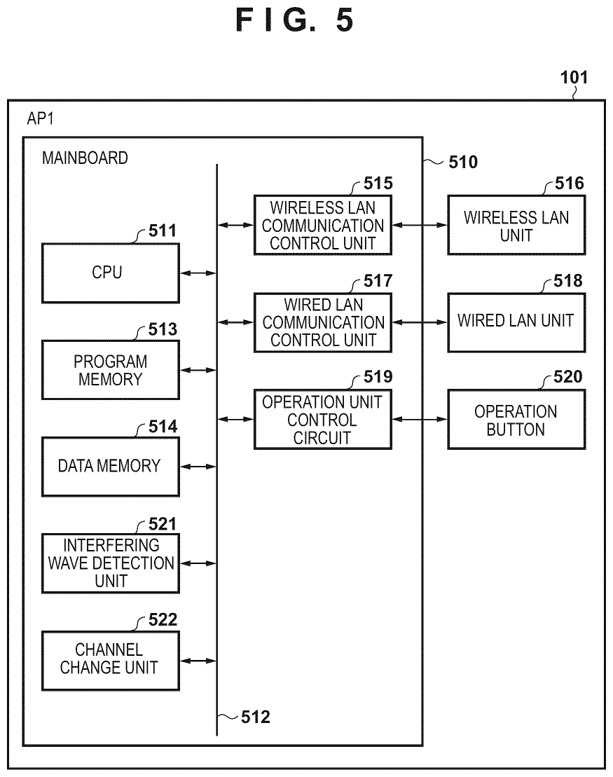

FIG. 5 is a block diagram illustrating the configuration of the AP 101 with a wireless LAN access point function. The AP 101 includes a mainboard 510 for performing control of the AP 101, a wireless LAN unit 516, a wired LAN unit 518, and an operation button 520.

A CPU 511 in the form of a microprocessor disposed on the mainboard 510 operates according to a control program stored in a program memory 513 in the form of ROM connected via an internal bus 512, the stored content of a data memory 514 in the form of RAM, and the like. The CPU 511 performs wireless LAN communication with other communication apparatuses by controlling the wireless LAN unit 516 via a wireless LAN communication control unit 515. Also, the CPU 511 performs wired LAN communication with other communication apparatuses by controlling the wired LAN unit 518 via a wired LAN communication control unit 517. The CPU 511 can receive operations from the user via the operation button 520 by controlling an operation unit control circuit 519. The CPU 511 includes at least one processor.

Also, the AP 101 includes an interference wave detection unit 521 and a channel change unit 522. The interference wave detection unit 521 executes interference detection processing during wireless communication in a band where dynamic frequency selection (DFS) is performed. The channel change unit 522 executes processing to change the channel to use when an interference wave is detected, when an empty channel needs to be immediately changed to, and the like during wireless communication in a band where DFS is performed.

### P2P Communication Method

Next, in WLAN communication, wireless direct communication (P2P (WLAN) communication, also referred to as P2P communication below) via wireless direct mode for apparatuses without involving an external access point will be described. P2P communication can be implemented using a plurality of modes. For example, a communication apparatus can support a plurality of modes for P2P communication and can perform P2P communication selectively using one of the plurality of modes.

The following two modes are examples of P2P communication modes.
SoftAP mode
Wi-Fi Direct (WFD) mode
   The communication apparatus that can execute P2P communication may be configured to support at least one of the plurality of modes. On the other hand, a communication apparatus that can perform P2P communication does not mean that all of the modes are supported, and the communication apparatus may be configured to only support a portion of the modes.

### SoftAP Mode

In SoftAP mode, the communication apparatus (for example, the mobile terminal apparatus 104) operates as a client that requests the various types of service. Another communication apparatus (for example, the MFP 100) operates as a soft AP that can execute a WLAN AP function set by the software. Note that it is sufficient that the commands and parameters transmitted and received when establishing a wireless connection between the client and the soft AP are as specified by Wi-Fi (registered trademark) standards, and thus description thereof will be omitted. Also, the MFP 100 that operates in the SoftAP mode determines the frequency band and the frequency channel as a master station. Thus, the MFP 100 can select which frequency range to use from among the 2.4 GHz, 5 GHz, or 6 GHz frequency band, for example, and which frequency channel to use in the frequency band. In SoftAP mode, there may be no negotiation for determining the role, and the WFD standard established by the Wi-Fi Alliance may not be complied with.

### WFD Mode

In the present embodiment, the mobile terminal apparatus 104 and the MFP 100 support a standard released as Wi-Fi Direct (WFD). Wi-Fi Direct is a function for enabling a Wi-Fi Direct-compatible device to establish an original Wi-Fi network without the need of an Internet connection. Specifically, Wi-Fi Direct-compatible devices such as the mobile terminal apparatus 104 and the MFP 100 can directly connect even in an environment without the AP 101 or the like. With a communication apparatus (for example, the mobile terminal apparatus 104) having a communication function using WFD, when a user operation is received via the operation unit, an application (dedicated is some cases) for implementing the communication function is invoked. Then, the communication apparatus displays a user interface (UI) screen provided by the application and prompts for a user operation. WFD communication may be performed on the basis of the user operation received in response to this. In WFD mode, negotiation (GO Negotiation) to determine which apparatus is to operate as the group owner and which as the client is performed. The MFP 100 operating as the group owner can select which frequency range to use from among the 2.4 GHz, 5 GHz, or 6 GHz frequency band, for example, and which frequency channel to use in the frequency band. The MFP 100 may be configured to be constantly active as a WFD mode master station (autonomous group owner). This makes GO Negotiation processing for determining roles unnecessary.

### Wireless Infrastructure Mode

In the wireless infrastructure mode, the communication apparatuses (for example, the mobile terminal apparatus 104 and the MFP 100) that communicate with one another are connected to an external AP (for example, the AP 101) controlling the network, and communication between the communication apparatuses is performed via the AP. In other words, communication between the communication apparatuses is performed via the network formed by the external AP. The mobile terminal apparatus 104 and the MFP 100 each discover the AP 101, transmit a connection request to the AP 101, and connect to the AP 101. This enables communication between the communication apparatuses in the wireless infrastructure mode via the AP 101. Note that the plurality of communication apparatuses may connect to different APs. In this case, the communication apparatuses can communicate by data being transferred between APs. Note that it is sufficient that the commands and parameters transmitted and received when the communication apparatuses communicate via the access point are as specified by Wi-Fi standards, and thus description thereof will be omitted. Also, in this case, the AP 101 determines the frequency band and the frequency channel. Thus, the AP 101 can select which frequency range to use from among the 2.4 GHz, 5 GHz, or 6 GHz frequency band, for example, and which frequency channel to use in the frequency band.

In the WFD standard described below, there is a first standard method and a second standard method different from the first standard method. In other words, in the WFD standard, there are a plurality of methods of different standard versions. Here, the first standard method will be referred to as WFD R1 (release 1), and the second standard method will be referred to as WFD R2 (release 2). In the WFD R1 and the WFD R2, the apparatus search and parameter sharing methods are different. Note that in the present embodiment, parameter sharing includes transmitting and receiving (exchanging) a parameter via communication between apparatuses without a user operation and parameter information being recognized by each apparatus via a user operation such as the scanning of a QR code (registered trademark).

### First Connection Processing via First Standard Method

The mobile terminal apparatus 104 and the MFP 100 support a standard released as Wi-Fi Direct. Wi-Fi Direct is a standard for enabling a Wi-Fi Direct-compatible device to establish an original Wi-Fi network without the need of an Internet connection. Specifically, Wi-Fi Direct-compatible devices such as the mobile terminal apparatus 104 and the MFP 100 can directly connect even in an environment without the AP 101 or the like.

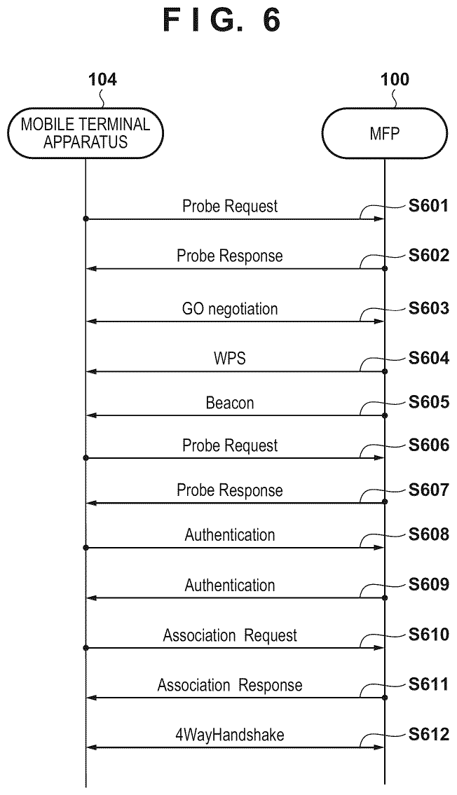

FIG. 6 is a sequence diagram of processing for connecting the mobile terminal apparatus 104 and the MFP 100 in a manner compliant with the WFD standard. Here, the WFD R1 connection processing sequence is illustrated. The processing executed by each apparatus in the present sequence is implemented by the CPU of each apparatus reading out to the RAM and executing various types of programs stored in the ROM or similar memory of each apparatus.

For example, the processing of the sequence is started when a WFD start instruction is received from a user in the mobile terminal apparatus 104 and the MFP 100. When a WFD start instruction is received, the mobile terminal apparatus 104 and the MFP 100 search for the partner apparatus by repeating a listen state and a search state. A time period for scanning each channel may be provided before each state. For example, in the listen state, for example, 1 ch of 2.4 GHz is selected and a Probe Request frame from another communication apparatus is waited for. In the search state, a Probe Request frame is transmitted while the frequency channels (for example, 1 ch, 6 ch, and 11 ch) are switched and a Probe Response frame is waited for.

In S601, the mobile terminal apparatus 104 transmits a Probe Request frame for searching for a WFD-compatible device. A partner apparatus on the searched side is searched for by transmitting a Probe Request frame. Here, the communication apparatus on the searching side is the mobile terminal apparatus 104, and the partner apparatus on the searched side is the MFP 100. The Probe Request frame includes a WFD attribute (P2P IE), and this identifies the search target as a WFD-compatible device.

In S602, when the MFP 100 receives the Probe Request frame, the MFP 100 transmits a Probe Response frame. The mobile terminal apparatus 104 detects the MFP 100, which is a WFD-compatible device, by receiving the Probe Response frame transmitted by the MFP 100. Note that the Probe Request frame and the Probe Response frame may include P2P IE and may included a Multi-Link element. A Multi-Link element may include a communication parameter used in Multi-Link communication as specified in the IEEE 802.11be standard. Accordingly, a plurality of links can be set between the communication apparatuses via one connection process. In this manner, in WFD R1, the presence of another WFD-compatible device may be detected using first search processing using a probe request frame/probe response frame. The first search processing described above corresponds to the search sequence of WFD R1.

In S603, the mobile terminal apparatus 104 and the MFP 100 execute GO Negotiation processing. In GO Negotiation, a channel used in wireless direct communication may be determined. In GO Negotiation processing, the mobile terminal apparatus 104 and the MFP 100 send and receive a GO Negotiation Request frame/GO Negotiation Response frame including an intent value for becoming the GO. The roles of the group owner (GO) and the client are determined by the GO Negotiation Request frame/GO Negotiation Response frame. The MFP 100 may be configured to be constantly active as a WFD mode master station (GO) (autonomous group owner). This makes GO Negotiation processing for determining roles unnecessary. When the intent value of the MFP 100 is set to the maximum 15, GO Negotiation processing is executed, but the MFP 100 may be made to always operate as the GO. Also, in this case, the MFP 100 determines the frequency band and the frequency channel to use in wireless direct communication as a master station. In this case, the MFP 100 can select which frequency range to use from among the 5 GHz frequency band and the 2.4 GHz frequency band and which frequency channel to use in the frequency band.

In S604, the mobile terminal apparatus 104 and the MFP 100 perform communication parameter sharing via Wi-Fi Protected Setup (WPS) processing. The communication parameter may include a service set identifier (SSID), an encryption method, an encryption key, an authentication method, AKM, a BSSID, a MAC address, and/or other similar parameters used in wireless communication. AKM is an abbreviation for Authentication and Key Management. AKM indicates an authentication protocol or key exchange algorithm used in wireless communication. For example, in a case where AKM is “SAE”, the communication parameters may include a password for connecting to the AP or GO corresponding to Wi-Fi Protected Access (WPA) 3. Also, in a case where AKM is “psk”, the communication parameters may include a Pre Shared Key (PSK) /passphrase for connecting to the AP or GO corresponding to WPA2. In a case where AKM is “1X”, the communication parameter may include an ID, password, public key, and the like for connecting to the AP corresponding to WPA-Enterprise. Note that the password and PSK/passphrase are encryption keys for when executing authentication or key exchange based on WPA or IEEE 802.11. The processing via WPS of S604 is a sharing sequence of a communication parameter for WFD R1. In the processing of S604 onward, a channel changed from the channel used in S601 to S603 may be used in communication.

In S605, when the MFP 100 determines that it is to operate as the GO, the MFP 100 starts transmitting a Beacon frame. The Beacon frame may include a communication parameter for communicating with the MFP 100. The Beacon frame may also include an information element (IE), attribute, or the like specified in the WFD standard. Accordingly, a WFD-compatible device other than the mobile terminal apparatus 104 can also detect the existence of the MFP 100 and can connect to the MFP 100 via wireless direct communication. For example, another WFD-compatible device may detect the existence of the MFP 100 by receiving a Beacon frame including information specified in the WFD standard.

In S606, the mobile terminal apparatus 104 transmits a Probe Request frame for executing a connection process with the MFP 100. In S607, when the MFP 100 receives the Probe Request frame, the MFP 100 transmits a Probe Response frame.

In S608, the mobile terminal apparatus 104 transmits an Authentication frame. In S609, when the MFP 100 receives the Authentication frame, the MFP 100 transmits an Authentication frame.

In S610, when the mobile terminal apparatus 104 receives the Authentication frame, the mobile terminal apparatus 104 transmits an Association Request frame. In S611, when the MFP 100 receives the Association Request frame, the MFP 100 transmits an Association Response frame.

In S612, the mobile terminal apparatus 104 and the MFP 100 execute a 4-way handshake.

In the first standard method, a connection (WFD connection) between the mobile terminal apparatus 104 and the MFP 100 is established by executing a connection process such as that described above. Also, though not mentioned in the sequence described above, the mobile terminal apparatus 104 and the MFP 100 may transmit and receive a Provision Discovery Request frame/Provision Discovery Response frame. Also, in the sequence of FIG. 6, the mobile terminal apparatus 104 and the MFP 100 may be reversed.

### Second Connection Processing via Second Standard Method

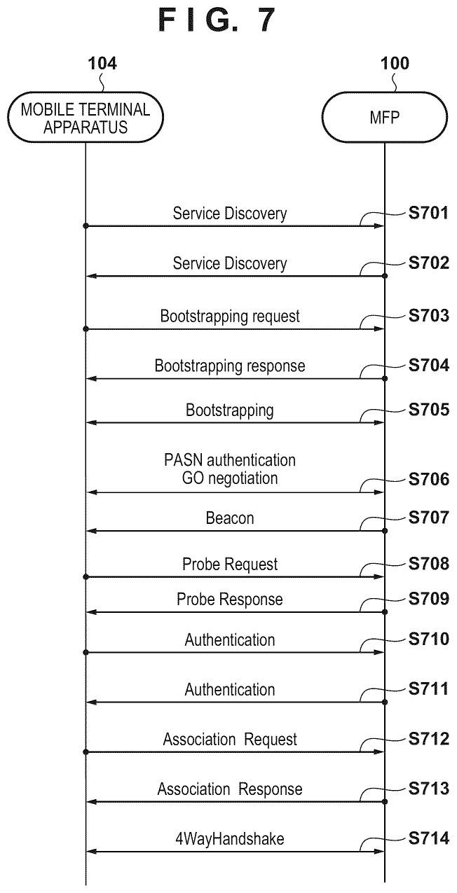

FIG. 7 is a sequence diagram of processing for connecting the mobile terminal apparatus 104 and the MFP 100 in a manner compliant with the WFD standard. Here, the WFD R2 connection processing sequence is illustrated. The processing executed by each apparatus in the present sequence is implemented by the CPU of each apparatus reading out to the RAM and executing various types of programs stored in the ROM or similar memory of each apparatus.

For example, the processing of the sequence is started when a WFD start instruction is received from a user in the mobile terminal apparatus 104 and the MFP 100. In the WFD R2 search sequence, second search processing is executed. An example of the search process using the second search processing is illustrated. In the search process, each of the mobile terminal apparatus 104 and the MFP 100 executes processing based on whether it is a communication apparatus on the service provider side or a communication apparatus on the service requester side and detects the other communication apparatus. The communication apparatus on the service provider side may be referred to as a publisher, a listener, an advertiser, or the like. The communication apparatus on the service requester side may be referred to as a subscriber, a searcher, a seeker, or the like. For example, the communication apparatus on the service requester side may transmit a frame for detecting the other WFD-compatible device. Also, the communication apparatus on the service provider side may receive a frame transmitted by the other WFD-compatible device and respond to it. The role allocated to the communication apparatus may be determined by a higher level layer (service layer or the like).

In the example described using FIG. 7, the mobile terminal apparatus 104 operates as a communication apparatus on the service requester side and the MFP 100 operates as a communication apparatus on the service provider side. For example, the mobile terminal apparatus 104 intermittently executes the detection operation and transmits a frame for detecting the other WFD-compatible device. In the second search processing, for example, a mechanism of the Wi-Fi Aware standard established by the Wi-Fi Alliance may be used. In other words, in the second search processing, as the communicated frame, a frame specified in the Wi-Fi Aware standard may be used. Other service search protocols and methods not only of the Wi-Fi Aware standard may be used in the second search processing.

In S701, the mobile terminal apparatus 104 transmits a Service Discovery frame for searching for a WFD-compatible device. Here, the Service Discovery frame is transmitted using 6 ch of 2.4 GHz. A partner apparatus on the searched side is searched for by transmitting a Service Discovery frame. Here, the communication apparatus on the searching side is the mobile terminal apparatus 104, and the partner apparatus on the searched side is the MFP 100. The Service Discovery frame includes a WFD attribute, and this identifies the search target as a WFD-compatible device.

In S702, when the MFP 100 receives the Service Discovery frame, the MFP 100 transmits a Service Discovery frame. The Service Discovery frame transmitted here is referred to as an SDF Follow up. The mobile terminal apparatus 104 detects the MFP 100, which is a WFD-compatible device, by receiving the Service Discovery frame. The second search processing described above corresponds to the search sequence of WFD R2. The first search processing of WFD R1 and the second search processing of WFD R2 are different in terms of method, and a communication apparatus that supports only WFD R1 cannot search using the WFD R2 method. Inversely, a communication apparatus that only supports WFD R2 cannot search using the WFD R1 method.

In S703, the mobile terminal apparatus 104 transmits a request using a Bootstrapping Request frame. The request here is a request relating to a sharing method for sharing a communication parameter. The mobile terminal apparatus 104 may use this frame to notify the MFP 100 of the sharing method executable by itself from among the sharing methods for communication parameters used in a button method (consent operation method), pincode, passphrase, QR code, near field communication (NFC) tag, and the like. Note that in the example according to the present embodiment described here, a QR code is used as an example of a two-dimensional code image. For example, in a case where a sharing method using a QR code can be executed, the mobile terminal apparatus 104 may indicate at least whether it can display a QR code or whether it can scan a QR code. Also, in a case where a sharing method using a passphrase can be executed, the mobile terminal apparatus 104 may indicate whether either one of a character string or numerical values or both can be used. Note that in a case where a sharing method using a passphrase can be executed, the mobile terminal apparatus 104 may indicate at least whether a passphrase can be displayed or whether a passphrase can be input. Also, the mobile terminal apparatus 104 may indicate whether a sharing method for a communication parameter using a button press can be used. The information that can be communicated to the mobile terminal apparatus 104 is not limited to these.

In S704, when the MFP 100 receives a Bootstrapping Request frame, the MFP 100 transmits a Bootstrapping Response frame to the mobile terminal apparatus 104. For example, the MFP 100 selects a sharing method that it can execute from among the sharing methods included in the request from the mobile terminal apparatus 104 and transmits a response including information that can identify the sharing method. In a case where there are no methods that can be executed among the sharing methods included in the request, the MFP 100 transmits a response including information indicating this.

In S705, Bootstrapping processing using the sharing method for sharing a communication parameter determined between the communication apparatuses is executed, and communication parameter sharing is executed. For example, communication parameter sharing is performed by the MFP 100 displaying the QR code and the mobile terminal apparatus 104 scanning the QR code. The Bootstrapping processing of S705 is a sharing sequence of a communication parameter for WFD R2. The communication parameter shared here may include at least one (one or a plurality of) a parameter used in wireless communication from among an encryption method, an encryption key, an authentication method, an AKM, and a BSSID (MAC address). Also, in the case of parameter sharing using a QR code, a passphrase may also be included. The parameter obtained here is used in the PASN authentication in S706, the Authentication in S710, and the Association Request in S712 described below.

In S706, mutual authentication is executed via PASN authentication. PASN is an abbreviation for Preassociation Security Negotiation. The communication parameter for using PASN may include a public key of each communication apparatus and the like. The communication parameter for using PASN may be shared using a method not specified in Bluetooth, Bluetooth Low Energy, or a similar WFD standard. In another example of a sharing method, a temporary network including an AP may be formed, and the communication parameters may be obtained by the communication apparatus connecting to that network. In PASN, the mobile terminal apparatus 104 and the MFP 100 may execute GO Negotiation processing. In GO Negotiation processing, a channel used in wireless direct communication may be determined. In GO Negotiation processing, the roles of the P2P group owner (GO) and the P2P client are determined. The MFP 100 may be configured to be constantly active as a WFD mode master station (autonomous group owner). This makes GO Negotiation processing for determining roles unnecessary. When the intent value of the MFP 100 is set to the maximum 15, GO Negotiation processing is executed, but the MFP 100 may be made to always operate as the MFP 100. Also, in this case, the MFP 100 determines the frequency band and the frequency channel to use in wireless direct communication as a master station. In this case, the MFP 100 can select which frequency range to use from among the 2.4 GHz, 5 GHz, or 6 GHz frequency band, for example, and which frequency channel to use in the frequency band.

In WFD R1, the frequency bands that can be used in wireless direct communication is 2.4 GHz and 5 GHz. However, In WFD R2, the frequency bands that can be used in wireless direct communication are 2.4 GHz and 5 GHz as well as 6 GHz. Also, in WFD R2, role determination is performed after sharing of the communication parameter, which is different from WFD R1. In the processing of S707 onward, a channel changed from the channel used in S701 to S706 may be used in communication.

In S707, when the MFP 100 determines that it is to operate as the GO, the MFP 100 starts transmitting a Beacon frame. The Beacon frame may include a communication parameter for communicating with the MFP 100. The Beacon frame may also include an information element (IE), attribute, or the like specified in the WFD standard. Accordingly, a WFD-compatible device other than the mobile terminal apparatus 104 can also detect the existence of the MFP 100 and can connect to the MFP 100. For example, another WFD-compatible device may detect the existence of the MFP 100 by receiving a Beacon frame including information specified in the WFD standard.

In S708, the mobile terminal apparatus 104 transmits a Probe Request frame for executing a connection process with the MFP 100. In S709, when the MFP 100 receives the Probe Request frame, the MFP 100 transmits a Probe Response frame.

In S710, the mobile terminal apparatus 104 transmits an Authentication frame. In S711, when the MFP 100 receives the Authentication frame, the MFP 100 transmits an Authentication frame.

In S712, when the mobile terminal apparatus 104 receives the Authentication frame, the mobile terminal apparatus 104 transmits an Association Request frame. In S713, when the MFP 100 receives the Association Request frame, the MFP 100 transmits an Association Response frame.

In S714, the mobile terminal apparatus 104 and the MFP 100 execute a 4-way handshake.

In the second standard method, a connection (WFD connection) between the mobile terminal apparatus 104 and the MFP 100 is established by executing a connection process such as that described above. In the sequence of FIG. 7, the mobile terminal apparatus 104 and the MFP 100 may be reversed. Also, whether WFD R1 is supported or whether WFD R2 is supported may be indicated in the P2P IE.

In an environment where a device that supports both the first standard method and the second standard method exists, there may be a case where a WFD connection cannot be performed between both devices. For example, in a case where a printer and a mobile terminal apparatus held by a normal user are used, if the administrator sets the WFD R2 to be used at the printer and the mobile terminal apparatus operates using WFD R1, the mobile terminal apparatus cannot perform a WFD connection to the printer, meaning that the user cannot use the printer.

Here, with the present embodiment, firstly, the user can select whether to search for a WFD-compatible device using at least one of the WFD R1 and the WFD R2. Then, a screen of a list of discovered (found) devices in which the discovered devices and the method used in searching for the device are associated is displayed, allowing the user to select them. The user can designate a WFD method for operation of the printer depending on the WFD method supported by the device that the user holds. Accordingly, the possibility of succeeding in WFD connection can be increased.

Hereinafter, the operation mode of the MFP 100 that executes WFD using WFD R1 will be referred to as R1 mode, and the operation mode of the MFP 100 that executes WFD using WFD R2 will be referred to as R2 mode. In other words, the search processing in R1 mode corresponds to the first search processing described above, and the device discovered via the first search processing operates in the R1 mode in a similar manner to the MFP 100. Also, the search processing in R2 mode corresponds to the second search processing described above, and the device discovered via the second search processing operates in the R2 mode in a similar manner to the MFP 100.

Before describing the processing for designating the WFD method in the MFP 100, a user interface relating to the mobile portal displayed on the MFP 100 will be described.

FIG. 8A illustrates an example of a menu screen displayed in a case where “mobile portal” is selected on the screen of FIG. 3B. On the menu screen of the mobile portal, buttons “Automatic”, “R2”, “R1”, “Do not search”, “Info”, and “End” are displayed as menu items (options). The “Automatic”, “R2”, and “R1” buttons each represent a search mode for searching for a WFD-compatible device in the surroundings capable of a WFD connection. When the “R2” button is selected (pressed), the MFP 100 searches for a WFD-compatible device in the surroundings via the R2 mode. The R2 mode is one of the operation modes of the MFP 100 described above, and in other words is one search mode for WFD-compatible devices in the surroundings.

When the “R1” button is selected, the MFP 100 searches for a WFD-compatible device in the surroundings via the R1 mode. When the “R1” button is selected, the MFP 100 searches for a WFD-compatible device in the surroundings via the R1 mode. The R1 mode is one of the operation modes of the MFP 100 described above, and in other words is one search mode for WFD-compatible devices in the surroundings.

When “Automatic” is selected, the MFP 100 sequentially performs both a search for a WFD-compatible device in the surroundings via the R1 mode and a search for a WFD-compatible device in the surroundings via the R2 mode. Note that the order at this time may be such that a search for a WFD-compatible device in the surroundings via the R1 mode is performed first or that a search for a WFD-compatible device in the surroundings via the R2 mode is performed first. In the present embodiment, the search mode for a WFD-compatible device in the surroundings when the “Automatic” button is selected is referred to as the automatic mode.

In this manner, in the present embodiment, the user can select which WFD method to use for searching for a WFD-compatible device in the surroundings on the user interface screen. Accordingly, the user can make a selection according to the WFD method supported by the mobile terminal apparatus 104 held by the user. Thus, the possibility of succeeding in a WFD connection between the MFP 100 and the mobile terminal apparatus 104 can be increased.

The “Do not search” button is a button for not executing a search for a device in the surroundings and waiting for a WFD connection request from an external device. In a case where the “Do not search” button is selected, the MFP 100 performs control to enter a waiting state for waiting for a WFD connection request via a method with higher security, for example. Specifically, for example, the MFP 100 performs control to enter a waiting state for waiting for a WFD connection request via the R2 mode. Note that a WFD connection request is, for example, a Service Discovery request frame or a Probe Request frame. As described above, the first search processing of WFD R1 and the second search processing of WFD R2 are different in terms of method, and a communication apparatus that supports only WFD R1 cannot be discovered using the WFD R2 method. Inversely, a communication apparatus that only supports WFD R2 cannot be discovered using the WFD R1 method. Accordingly, in a case where the MFP 100 enters a waiting state for waiting for a WFD connection request via the R2 mode, even if a Probe Request frame is received, a response to this frame is not performed.

The “Info” button is a button for displaying a description of each search mode of FIG. 8A, and when selected, a window listing the descriptions of each search mode is opened, for example. The “End” button is a button for receiving an instruction to end the display of the “mobile portal” screen.

FIG. 8B illustrates an example of a screen displayed in a case where “Automatic” is selected on the screen of FIG. 8A. As illustrated in FIG. 8B, a search for a WFD-compatible device via the automatic mode is displayed as being in progress. In the present embodiment, when the automatic mode is selected, both a search for a WFD-compatible device via the R2 mode and a search for a WFD-compatible device via the R1 mode are sequentially executed.

FIG. 8C illustrates an example of a screen indicating the search results via the automatic mode and the waiting state of the MFP 100. In FIG. 8C, as an example of the search results, “1234567890” and “1111111111” indicating devices discovered via the R2 mode and “abc” indicating a device discovered via the R1 mode are displayed. “1234567890”, “1111111111”, and “abc” correspond to identification information such as the SSID of each device. In FIG. 8C, a “Connect” button is provided corresponding to the identification information of each device, and an instruction to perform a WFD connection request for each device can be received. In the present embodiment, an example in which three devices are discovered as the search result is illustrated. However, in a case where more devices are discovered, a display with a more restricted range of the screen display may be performed, and all of the discovered devices may be made displayable by scrolling the screen or the like. In a case where a plurality of devices are discovered, a display order may be determined on the basis of the radio field intensity of the discovered device, security robustness, or the like. Also, the criteria for determining the display order may be able to be set by the user. On the screen of FIG. 8C, a “Execute search” button is provided, and an instruction for re-executing the search can be received. The “End” button is a button for receiving an instruction to end the display of the “mobile portal” screen.

On the screen of FIG. 8C, information of the waiting state of the MFP 100 is also displayed. In FIG. 8C, for example, “abcd”, which is the SSID of the MFP 100, is displayed. The “Waiting state via R2” of FIG. 8C indicates that the MFP 100 is in a waiting state for waiting for a WFD connection request via the R2 mode. The “QR code” button is a button for receiving an instruction to display a QR code for sharing a communication parameter between the MFP 100 and an external device. The “Detailed display” button is a button for receiving an instruction to display the detailed information of the MFP 100 such as the SSID and password of the MFP 100, security information, and the like. The “Switch to R1” button is a button for receiving an instruction to switch the MFP 100 to a waiting state for waiting for a WFD connection request via the R1 mode.

FIG. 8D illustrates an example of a screen displayed in a case where the “QR code” button is selected on the screen of FIG. 8C. In FIG. 8D, a QR code including the Bootstrapping information described using FIG. 7 is displayed. The device operating in the R2 mode can make a WFD connection to the MFP 100 by scanning the QR code displayed on the screen of FIG. 8D.

FIG. 8E illustrates an example of a screen displayed in a case where the “Detailed display” button is selected on the screen of FIG. 8C. On the screen of FIG. 8E, the detailed information of the MFP 100 is displayed. Specifically, for example, that the MFP 100 is in a waiting state for waiting for a WFD connection request via the R2 mode, the SSID of the MFP 100, the password, the frequency band, the security mode, and the like are displayed. For the password, a “Display” button is provided, and the password can be displayed in an identifiable manner by the “Display” button being selected. In the normal state, the password is displayed in a non-identifiable state. With the “Display” button, the user can switch between prioritizing security or user-friendliness.

FIG. 8F illustrates an example of a screen displayed in a case where the “Switch to R1” button is selected on the screen of FIG. 8C. When the “Switch to R1” button is selected, control is performed so that the waiting state of the MFP 100 is switched from a waiting state for waiting for a WFD connection request via the R2 mode to a waiting state for waiting for a WFD connection request via the R1 mode. In other words, a state in which a Probe Request frame can be responded to is switched to from a state in which a Service Discovery request frame of the second search processing can be responded to. When the waiting state is switched to the waiting state for waiting for a WFD connection request via the R1 mode, the display of “Waiting via R2” of the screen of FIG. 8C is updated to “Waiting via R1”.

FIG. 8G illustrates an example of a screen displayed in a case where the “Connect” button corresponding to “1234567890” indicating a device discovered via the R2 mode on the screen of FIG. 8C is selected. On the screen of FIG. 8G, a region for the user to input a PIN code when connecting is displayed. When the user inputs the PIN code presented for the connection target device via the number buttons displays on the lower half of the screen of FIG. 8G, a WFD connection can be made between the MFP 100 and the connection target device. In the present example, an example of connecting via input of a PIN code is described, but a screen for another connection authentication method mentioned in the description of FIG. 7 such as a method of scanning a QR via a scanner function of the MFP 100 may be displayed.

FIG. 8H illustrates an example of a screen illustrating a state in which the user has input a PIN code on the screen of FIG. 8G and selected the “OK” button and processing in progress for a WFD connection between the MFP 100 and the connection target device. On the screen of FIG. 8H, that the connection via WFD R2 between the MFP 100 and the “1234567890” device is in progress is displayed.

FIG. 8I illustrates an example of a screen indicating that the processing for a WFD connection between the MFP 100 and the connection target device is complete and a WFD connection has been established. On the screen of FIG. 8I, that a connection via WFD R2 between the MFP 100 and the “1234567890” device has been established is displayed.

FIG. 8J illustrates an example of a screen displayed in a case where no WFD-compatible device is discovered after the “Automatic” button is selected on the menu screen of FIG. 8A and after the screen of FIG. 8B. The screen of FIG. 8J corresponds to a case where the “Automatic” button is selected, in other words, a case where neither a device supporting WFD R2 nor a device supporting WFD R1 is discovered in the surroundings of the MFP 100.

FIG. 8K illustrates an example of a screen displayed in a case where no WFD-compatible device is discovered as a result of the “R1” button being selected on the screen of FIG. 8A and a search via the R1 mode being performed. In other words, that no device supporting WFD R1 has been discovered in the surroundings of the MFP 100 is indicated. The “Search via R2” button is a button for receiving an instruction for searching for a WFD-compatible device in the surroundings via the R2 mode. The “Wait screen” is a button for entering a waiting state for waiting for a WFD connection request from an external device. In a case where the “Wait screen” button is selected, for example, a waiting state for waiting for a WFD connection request via the R1 mode is entered. Note that in a case where the “R2” button is selected on the screen of FIG. 8A and no WFD-compatible device is discovered as a result of the search via the R2 mode, the screen of FIG. 8K is displayed with the “R1” and “R2” substituted with “R2” and “R1” (not illustrated).

FIG. 8L illustrates a screen displaying the waiting state of the MFP 100 waiting for a WFD connection request in a case where the screen of FIG. 8J or the screen of FIG. 8K is displayed, in other words, a case where no devices are discovered via each search mode of FIG. 8A. In FIG. 8L, for example, “abcd”, which is the SSID of the MFP 100, is displayed. The “Waiting state via R2” of FIG. 8L indicates that the MFP 100 is in a waiting state for waiting for a WFD connection request via the R2 mode. The “QR code” button is a button for receiving an instruction to display a QR code for sharing a communication parameter between the MFP 100 and an external device. The “Detailed display” button is a button for receiving an instruction to display the detailed information of the MFP 100 such as the SSID and password of the MFP 100, security information, and the like. The “Switch to R1” button is a button for receiving an instruction to switch the MFP 100 to a waiting state for waiting for a WFD connection request via the R1 mode. On the screen of FIG. 8L, an “Execute search” button is provided, and an instruction for re-executing the search can be received. The “End” button is a button for receiving an instruction to end the display of the “mobile portal” screen.

FIG. 8M illustrates an example of a screen displayed in a case where a WFD connection request is received from an external device while the MFP 100 is in a waiting state. On the screen, identification information of the device corresponding to the received WFD connection request is displayed. The identification information of the device is the SSID, for example. In FIG. 8M, for example, the identification information of the device and the operation mode of the device are displayed. The user checks the SSID of the device that transmitted the WFD connection request and checks that the device is operating in the R2 mode. Then, the user can press the “Yes” button to permit the exchange of the communication parameter via WFD R2. Also, the user can press the “No” button to reject the WFD connection request.

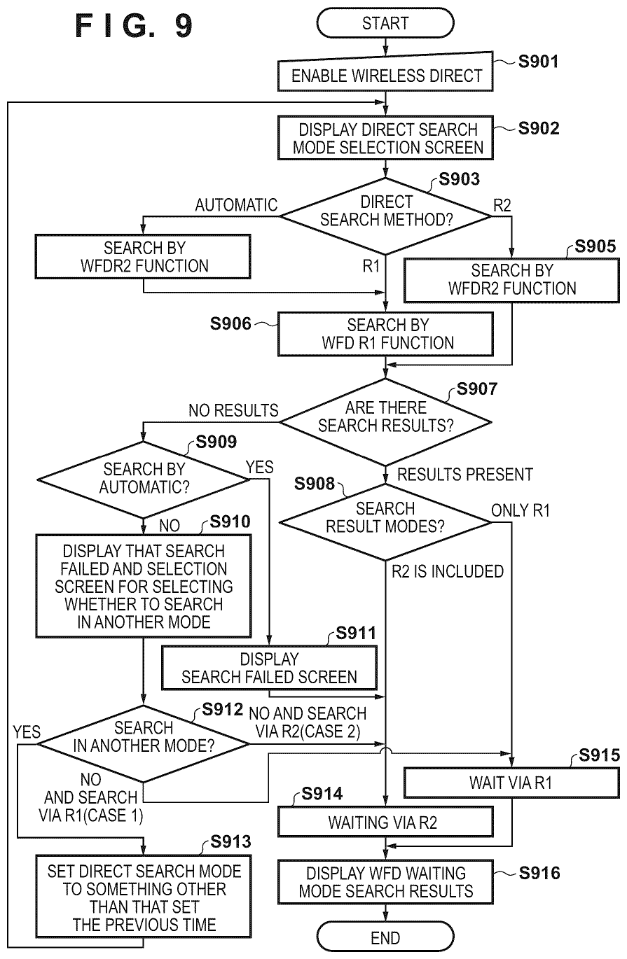

FIG. 9 is a flowchart illustrating the processing for activating the mobile portal in the MFP 100. The processing in FIG. 9 is implemented by the CPU 212 reading out a program stored in the ROM 213 into the RAM 214 and executing the program, for example. The processing of FIG. 9, for example, starts when “Mobile portal” is selected on the screen of FIG. 3B.

In S901, the CPU 212 detects processing for activating the mobile portal. Specifically, for example, the CPU 212 detects the selection operation of “Mobile portal” on the screen of FIG. 3B.

In S902, the CPU 212 displays the selection screen for the search mode for searching for a WFD-compatible device. Specifically, for example, the screen of FIG. 8A is displayed. The search mode selection screen may be controlled to not be displayed. For example, in a case where the search mode has been preset by the user, the processing of S902 may be skipped. The result selected on the search mode selection screen is stored in the RAM 214.

In S903, the CPU 212 determines which of the buttons on the search mode selection screen has been selected. Then, the CPU 212 executes a search for a WFD-compatible device via a different method on the basis of the button selected on the search mode selection screen. Specifically, for example, in a case where “Automatic” has been selected on the screen of FIG. 8A, the CPU 212 determines to execute the automatic mode, that is, a search for a WFD-compatible device in the surroundings via the R2 mode and a search for a WFD-compatible device in the surroundings via the R1 mode, and then the processing advances to S904. In a case where “R1” is selected on the screen of FIG. 8A, the CPU 212 determines to execute a search for a WFD-compatible device in the surroundings via the R1 mode, and then the processing advances to S906. In a case where “R2” is selected on the screen of FIG. 8A, the CPU 212 determines to execute a search for a WFD-compatible device in the surroundings via the R2 mode, and then the processing advances to S905. Note that though not illustrated in FIG. 9, in a case where “Do not search” is selected on the screen of FIG. 8A, no search is executed using any mode, and the processing advances to S916 described below.

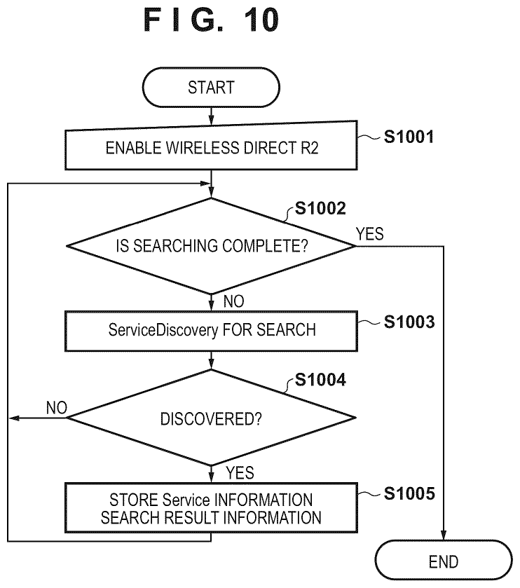

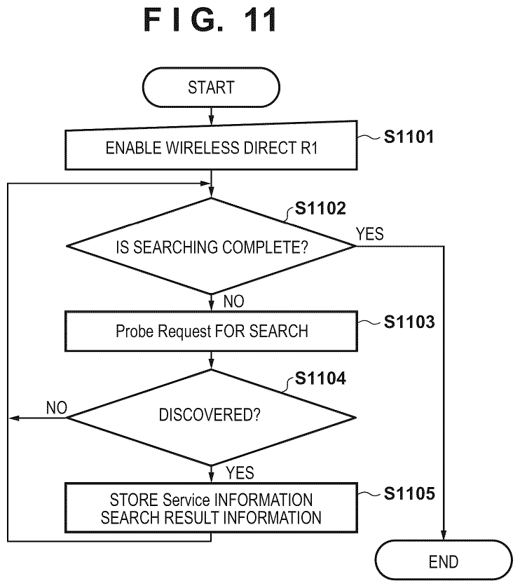

In S904, the CPU 212 executes a search for a WFD-compatible device in the surroundings via the R2 mode and stores the search result in the RAM 214 as search result information. Thereafter, in S906, the CPU 212 executes a search for a WFD-compatible device in the surroundings via the R1 mode and stores the search result in the RAM 214 as search result information. In other words, in a case where “Automatic” has been selected on the screen of FIG. 8A, for example, the screen of FIG. 8B is displayed and both a search for a WFD-compatible device in the surroundings via the R2 mode and a search for a WFD-compatible device in the surroundings via the R1 mode are executed. S907 follows S906. The processing of S904 is described below using FIG. 10, and the processing of S906 is described below using FIG. 11.

In a case where in S903 it is determined to execute a search for a WFD-compatible device in the surroundings via the R1 mode, the processing of S906 is executed. In other words, in a case where “R1” has been selected on the screen of FIG. 8A, for example, a search for a WFD-compatible device via the R1 mode is executed. S907 follows S906.

In a case where in S903 it is determined to execute a search for a WFD-compatible device in the surroundings via the R2 mode, in S905, the CPU 212 executes a search for a WFD-compatible device in the surroundings via the R2 mode and stores the search results in the RAM 214 as search result information. In other words, in a case where “R2” has been selected on the screen of FIG. 8A, for example, a search for a WFD-compatible device in the surroundings via the R2 mode is executed. S907 follows S905. The processing of S905 is described below using FIG. 10.

In S904, S905, and S906, the CPU 212 may obtain radio field intensity information of each device discovered. In this case, the radio field intensity information is stored in the RAM 214 as search result information.

In S907, the CPU 212 determines whether or not there is search result information stored in the RAM 214. In a case where it is determined that there is search result information, the processing advances to S908. In a case where it is determined that there is no search result information, the processing advances to S909.

In S908, the CPU 212 determines whether or not information of the device discovered via the R2 mode is included in the search result information. In a case where it is determined that the device discovered via the R2 mode is included in the search result information, the processing advances to S914. The case of advancing from S908 to S914 includes a case where only a device discovered via the R2 mode is included in the search result information and a case where both a device discovered via the R1 mode and a device discovered via the R2 mode are included in the search result information.

In S914, the CPU 212 controls the wireless unit 226 to put the MFP 100 in a waiting state that accepts a WFD connection request using the R2 mode but does not accept a WFD connection request using the R1 mode. Specifically, for example, the wireless unit 226 is controlled so that it can respond to the Service Discovery request frame of S701 of FIG. 7. Accordingly, in a case where a search for a WFD-compatible device in the surroundings via the R2 mode has been executed by an apparatus other than the mobile terminal apparatus 104, the MFP 100 can be discovered, and a WFD connection request can be transmitted to the MFP 100. Also, in a case where a search for a WFD-compatible device in the surroundings via the R1 mode has been executed by another apparatus, the MFP 100 cannot be discovered, and thus a WFD connection via the R1 mode being established can be prevented. S916 follows S914.

In the present embodiment, in a case where a device discovered via the R1 mode and a device discovered via the R2 mode are both present in the surroundings of the MFP 100, for example, the MFP 100 can enter a waiting state for waiting for a WFD connection request using the R2 mode with higher security robustness.

In a case where a device discovered via the R2 mode is not included in the search result information, that is, only a device discovered via the R1 mode is included in the search result information in S908, the processing advances to S915.

In S915, the CPU 212 controls the wireless unit 226 to put the MFP 100 in a waiting state that accepts a WFD connection request using the R1 mode but does not accept a WFD connection request using the R2 mode. Specifically, for example, the wireless unit 226 is controlled so that it can respond to the Probe Request frame of S601 of FIG. 6. Accordingly, in a case where a search for a WFD-compatible device in the surroundings via the R1 mode has been executed by an apparatus other than the mobile terminal apparatus 104, the MFP 100 can be discovered, and a WFD connection request can be transmitted to the MFP 100. Also, in a case where a search for a WFD-compatible device in the surroundings via the R2 mode has been executed by another apparatus, the MFP 100 cannot be discovered, and thus a WFD connection via the R2 mode being established can be prevented. S916 follows S915.

In S916, the CPU 212 displays a screen displaying the search for a WFD-compatible device results and the waiting state of the MFP 100. In a case where “Automatic” has been selected on the screen of FIG. 8A, as the search results, a result of a search for a WFD-compatible device in the surroundings via the R1 mode and a result of a search for a WFD-compatible device in the surroundings via the R2 mode are both displayed. Note that on the screen described above, an icon indicating whether a search via the R1 mode or a search via the R2 mode was used to discover each discovered WFD-compatible device may be displayed. In a case where “Automatic” is selected, the CPU 212 causes the MFP 100 to operate in a waiting state for waiting for a WFD connection request via the R1 mode or a waiting state for waiting for a WFD connection request via the R2 mode depending on whether or not the information of the device discovered using the R2 mode is included in the search result information. Thus, on the screen displayed here, information indicating which waiting state the MFP 100 is in is included.

In a case where “R1” has been selected on the screen of FIG. 8A, as the search results, the result of a search for a WFD-compatible device in the surroundings via the R1 mode is displayed. Note that in a case where “R1” has been selected, since a search for a WFD-compatible device in the surroundings via the R2 mode has not been executed, the result of a search for a WFD-compatible device in the surroundings via the R2 mode is not displayed. Also, in a case where “R1” has been selected, the CPU 212 causes the MFP 100 to operate in a waiting state that accepts a WFD connection request via the R1 mode but does not accept a WFD connection request via the R2 mode. Thus, on the screen displayed here, information indicating that the MFP 100 is in a waiting state for waiting for a WFD connection request via the R1 mode is included.

In a case where “R2” has been selected on the screen of FIG. 8A, as the search results, the result of a search for a WFD-compatible device in the surroundings via the R2 mode is displayed. Note that in a case where “R2” has been selected, since a search for a WFD-compatible device in the surroundings via the R1 mode has not been executed, the result of a search for a WFD-compatible device in the surroundings via the R1 mode is not displayed. Also, in a case where “R2” has been selected, the CPU 212 causes the MFP 100 to operate in a waiting state that accepts a WFD connection request via the R2 mode but does not accept a WFD connection request via the R1 mode. Thus, on the screen displayed here, information indicating that the MFP 100 is in a waiting state for waiting for a WFD connection request via the R2 mode is included.

In the present processing, specifically, the screen of FIG. 8C is displayed, for example. A case where the screen of FIG. 8C is displayed in S916 includes a case where “Automatic” has been selected on the screen of FIG. 8A and a device has been discovered via both a search for a WFD-compatible device in the surroundings via the R1 mode and a search for a WFD-compatible device in the surroundings via the R2 mode. The user can recognize via the screen of FIG. 8C that the MFP 100 is in a waiting state for waiting for a WFD connection request via the R2 mode. Also, the user can identify the devices discovered via the R2 mode and the devices discovered via the R1 mode. The user can instruct for a WFD connection to be made with a desired device from among the discovered devices. Also, the user can switch the operation mode of the MFP 100 according to the WFD method supported by the mobile terminal apparatus 104 held by the user. For example, in a case where the mobile terminal apparatus 104 of the user supports WFD R1, the user can switch the waiting state of the MFP 100 to a waiting state for waiting for a WFD connection request via the R1 mode. For example, in a case where the mobile terminal apparatus 104 of the user supports WFD R2, the user can cause the MFP 100 to display a QR code for sharing the communication parameter in the R2 mode. After S916, the processing of FIG. 9 ends. Note that in a case where the screen displayed by the MFP 100 is switched to a different screen by the operation of the “End” button on the screen displayed in S916 or the like, the CPU 212 may control the MFP 100 to stop the operations in the waiting state for waiting for a WFD connection request. In other words, the CPU 212 may be configured so that another apparatus can discover the MFP 100 via a search for a WFD-compatible device only while the screen displayed in S916 is displayed by the MFP 100. In other words, configuration may be such that in a state where the screen displayed in S916 is not displayed by the MFP 100, another apparatus cannot discover the MFP 100 via a search for a WFD-compatible device.

In S909 executed in a case where NO is determined in S907, the CPU 212 determines whether or not the search mode indicated by the result selected by the user on the search mode selection screen displayed in S902 is the automatic mode. The automatic mode is a mode in which both a search for a WFD-compatible device in the surroundings via the R2 mode and a search for a WFD-compatible device in the surroundings via the R1 mode are executed. In the present processing, specifically, the CPU 212 determines whether or not “Automatic” has been selected on the screen of FIG. 8A, for example.

In a case where it is determined to be the automatic mode (that “Automatic” has been selected) in S909, in S911, the CPU 212 displays a screen indicating that the search has failed. Specifically, the screen of FIG. 8J is displayed, for example. In S911, if the OK button is selected on the screen of FIG. 8J, for example, the processing advances to S914, and the CPU 212 puts the MFP 100 in a waiting state for waiting for a WFD connection request via the R2 mode. Thereafter, in S916, the CPU 212 displays a screen indicating that the MFP 100 is in a waiting state for waiting for a WFD connection request via the R2 mode and that there are no discovered devices. Specifically, the screen of FIG. 8L is displayed, for example.

In the present embodiment, in a case where no devices are discovered via either the R2 mode or the R1 mode, the MFP 100 transitions to a waiting state for waiting for a WFD connection request via the R2 mode. This can improve the security robustness in the waiting state. However, in a case where no devices are discovered via either the R2 mode or the R1 mode, the MFP 100 may transition to a waiting state for waiting for a WFD connection request via the R1 mode. In this case, the processing advances from S911 to S915 instead of to S914.

In a case where it is determined to not be the automatic mode (that a button other than “Automatic” has been selected) in S909, in S910, the CPU 212 displays a screen indicating that the search has failed. Specifically, the screen of FIG. 8K is displayed, for example. A case where the screen of FIG. 8K is displayed includes a case where “R1” has been selected on the screen of FIG. 8A and even though a search for a WFD-compatible device in the surroundings via the R1 mode has been executed, there are no discovered devices. In a case where “R2” has been selected on the screen of FIG. 8A and even though a search for a WFD-compatible device in the surroundings via the R2 mode has been executed, there are no discovered devices, a screen (not illustrated) indicating that there are no discovered devices is displayed. Such a screen may be the screen of FIG. 8K with “R1” and “R2” substituted with “R2” and “R1”. S912 follows S910.

In S912, the CPU 212 determines whether or not to execute another search mode. Specifically, for example, whether or not “Search via R2” has been selected on the screen of FIG. 8K is determined. In a case where it is determined that another search mode is to be executed, the processing advances to S913.

In S913, the CPU 212 performs settings for another search mode to be executed, and the processing from S903 is repeated. Specifically, for example, in a case where “Search via R2” has been selected on the screen of FIG. 8K, a search via the R2 mode is set to be executed, and the processing from S903 is repeated. In this case, the processing of S905 is executed. Also, on a screen (not illustrated) displayed in S910 indicating that, even though a search for a WFD-compatible device in the surroundings via the R2 mode has been executed, there are no discovered devices, a “Search via R1” button is displayed. Then, in a case where the user selects “Search via R1”, in S913, setting is performed to execute a search via the R1 mode and the processing from S903 is repeated. In this case, the processing of S906 is executed.

In a case where it is determined to not execute another search mode in S912, on the basis of the search mode currently set, the MFP 100 is controlled to enter a waiting state for waiting for a WFD connection request via the R2 mode or a waiting state for waiting for a WFD connection request via the R1 mode. Specifically, for example, in a case where “Waiting screen” is selected on the screen of FIG. 8K, the currently set search mode is the R1 mode, and thus the processing advances to S915 (Case 1), and the CPU 212 puts the MFP 100 in a waiting state for waiting for a WFD connection request via the R1 mode. Thereafter, in S916, the CPU 212 displays a screen (not illustrated) indicating that the MFP 100 is in a waiting state for waiting for a WFD connection request via the R1 mode and that there are no discovered devices. On the other hand, on a screen (not illustrated) indicating that, even though a search via the R2 mode has been executed, there are no discovered devices, a “Waiting screen” button is displayed in addition to the “Search via R1” button. Then, in a case where “Waiting screen” is selected on the screen, the currently set search mode is the R2 mode, and thus the processing advances to S914 (Case 2), and the CPU 212 puts the MFP 100 in a waiting state for waiting for a WFD connection request via the R2 mode. Thereafter, in S916, the CPU 212 displays the screen of FIG. 8L indicating that the MFP 100 is in a waiting state for waiting for a WFD connection request via the R2 mode and that there are no discovered devices.

In the example of the present embodiment described above, in a case where a device that supports WFD R1 and a device that supports WFD R2 are both present in the surroundings of the MFP 100, the MFP 100 enters a waiting state for waiting for a WFD connection request via the R2 mode with high security robustness. However, the configuration is not limited thereto. For example, in a case where the device that supports WFD R1 is the device with the highest radio field intensity in an environment in which a device that supports WFD R1 and a device that supports WFD R2 are both present, the MFP 100 may enter a waiting state for waiting for a WFD connection request via the R1 mode.

Though not illustrated in FIG. 9, in a case where “Execute search” is operated on the screen of FIG. 8C or the screen of FIG. 8L, the screen of FIG. 8A is displayed and the processing from S902 is repeated.

As described above, according to the present embodiment, in a case where “Mobile portal” has been selected on the screen of FIG. 3B, a search for a WFD-compatible device in the surroundings can be performed via the search mode selected by the user. Also, a WFD connection request can be waited for in a predetermined waiting state according to the environment of the surroundings after the search.

FIG. 10 is a flowchart illustrating the processing to search for a WFD-compatible device in the surroundings via the R2 mode in S904 and S905 of FIG. 9.

In S1001, the CPU 212 detects processing for enabling wireless direct via the R2 mode. Specifically, for example, the CPU 212 detects a selection operation of “Automatic” or “R2” on the screen of FIG. 8A.

In S1002, the CPU 212 determines whether or not the search processing of FIG. 10 has ended. In a case where it is determined that the search processing has ended, the processing of FIG. 10 is ended. Specifically, for example, in a case where a predetermined timeout time has elapsed, it is determined that the search processing has ended. Also, for example, in a case where the number of discovered devices reaches a predetermined upper limit, it is determined that the search processing has ended. In a case where it is determined that the search processing has not ended, the processing advances to S1003.

In S1003, the CPU 212 executes a search for a WFD-compatible device in the surroundings via the R2 mode. Specifically, for example, a Service Discovery request frame is transmitted outside.

In S1004, the CPU 212 determines whether or not there is a device discovered via the R2 mode. Specifically, for example, the CPU 212 determines whether or not a Service Discovery response frame has been received. In a case where a Service Discovery response frame is not received, that is, it is determined that there are no devices discovered via the R2 mode, the processing from S1002 is repeated. On the other hand, in a case where a Service Discovery response frame is received, that is, it is determined that there is a device discovered via the R2 mode, the processing advances to S1005, and the CPU 212 stores the Service information included in the received Service Discovery response frame and the search result information including the radio field intensity information of the device and the like in the RAM 214 in association with the information of the discovered device such as the SSID, for example. Thereafter, the processing from S1002 is repeated. As described above, a device that supports WFD R2 in the surroundings of the MFP 100 is searched for.

FIG. 11 is a flowchart illustrating the processing to search via the R1 mode in S906 of FIG. 9.

In S1101, the CPU 212 detects processing for enabling wireless direct via the R1 mode. Specifically, for example, the CPU 212 detects a selection operation of “Automatic” or “R1” on the screen of FIG. 8A.

In S1102, the CPU 212 determines whether or not the search processing of FIG. 11 has ended. In a case where it is determined that the search processing has ended, the processing of FIG. 11 is ended. Specifically, for example, in a case where a predetermined timeout time has elapsed, it is determined that the search processing has ended. Also, for example, in a case where the number of discovered devices reaches a predetermined upper limit, it is determined that the search processing has ended. In a case where it is determined that the search processing has not ended, the processing advances to S1103.

In S1103, the CPU 212 executes a search for a WFD-compatible device in the surroundings via the R1 mode. Specifically, for example, a Probe Request frame is transmitted outside.

In S1104, the CPU 212 determines whether or not there is a device discovered via the R1 mode. Specifically, for example, the CPU 212 determines whether or not a Probe Response frame has been received. In a case where a Probe Response frame is not received, that is, it is determined that there are no devices discovered via the R1 mode, the processing from S1102 is repeated. On the other hand, in a case where a Probe Response frame is received, that is, it is determined that there is a device discovered via the R1 mode, the processing advances to S1105, and the CPU 212 stores the Service information included in the received Probe Response frame and the search result information including the radio field intensity information of the device and the like in the RAM 214 in association with the information of the discovered device such as the SSID, for example. Thereafter, the processing from S1102 is repeated. As described above, a device that supports WFD R1 in the surroundings of the MFP 100 is searched for.

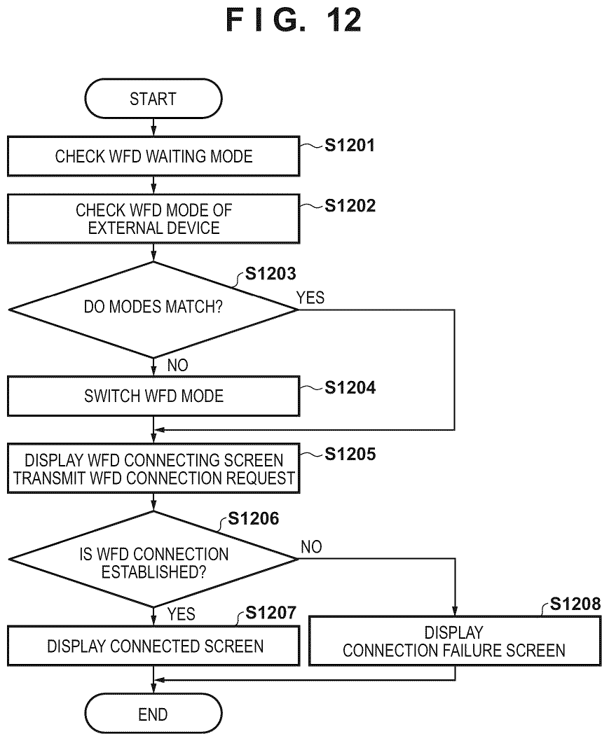

FIG. 12 is a flowchart illustrating processing for connecting the MFP 100 and a discovered device executed in a case where the MFP 100 is in a waiting state for a WFD connection request. The processing in FIG. 12 is implemented by the CPU 212 reading out a program stored in the ROM 213 into the RAM 214 and executing the program, for example.

Here, the MFP 100 is in a state in which the screen of FIG. 8C in S916 is displayed. In other words, as a result of a search for devices being performed, a device that supports WFD R2 and a device that supports WFD R1 have been discovered. Also, the MFP 100 is in a waiting state for waiting for a WFD connection request via the R2 mode. As illustrated in FIG. 8C, on the screen, a “Connect” button is individually provided corresponding to each discovered device. Processing in such a case when the “Connect” button of FIG. 8C is pressed will now be described.

In S1201, the CPU 212 obtains information of the operation mode of the MFP 100. Specifically, for example, if the MFP 100 is in a waiting state for waiting for a WFD connection request via the R1 mode, information indicating the R1 mode is obtained as the information of the operation mode of the MFP 100. Also, if the MFP 100 is in a waiting state for waiting for a WFD connection request via the R2 mode, information indicating the R2 mode is obtained as the information of the operation mode of the MFP 100.

In S1202, the CPU 212 obtains information of the operation mode of the device corresponding to the “Connect” button pressed by the user. Specifically, for example, in a case of a device discovered via a search for a WFD-compatible device in the surroundings via the R1 mode, information indicating the R1 mode is obtained as the information of the operation mode of the device. Also, in a case of a device discovered via a search for a WFD-compatible device in the surroundings via the R2 mode, information indicating the R2 mode is obtained as the information of the operation mode of the device.

In S1203, the CPU 212 determines whether or not the operation mode of the MFP 100 and the operation mode of the device corresponding to the “Connect” button match on the basis of the information of the operation mode obtained in S1201 and S1202. In a case where a match is determined, the processing advances to S1205. In a case where no match is determined, the processing advances to S1204.

In S1204, the CPU 212 controls the wireless unit 226 to change the operation mode of the MFP 100 to the operation mode of the device corresponding to the “Connect” button. Specifically, for example, in a case where the “Connect” button corresponding to “abc” of FIG. 8C has been pressed, the CPU 212 controls the wireless unit 226 to switch the operation mode of the MFP 100 from the R2 mode to the R1 mode.

In S1205, the CPU 212 displays a screen indicating that it is connecting to an external device and transmits a connection request. Specifically, for example, the CPU 212 displays the screen of FIG. 8H and transmits a connection request.

The connection request transmitted in S1205 corresponding to the device that supports WFD R1 is different from a Probe Request frame. In S1205, the CPU 212 executes the GO Negotiation of S603 of FIG. 6 as a connection request on the basis of the search result information including information of the Probe Response frame stored at the time of the device search. Then, via the sequence of FIG. 6, a WFD connection via the R1 mode is established. In this manner, in S1205, the connection process is executed from the GO Negotiation of S603, and in a case where time has passed from the time of the device search to when the user presses the “Connect” button or the like, the Probe Response frame information may not be valid. In this case, as the connection request, the Probe Request frame of S601 of FIG. 6 may be re-transmitted, and after a Probe Response frame is received from a device that supports WFD R1 selected by the user, GO Negotiation may be executed.

On the other hand, the connection request transmitted in S1205 corresponding to the device that supports WFD R2 is different from a Service Discovery request frame. In S1205, CPU 212 transmits the Bootstrapping Request frame of S703 of FIG. 7 as a connection request on the basis of the search result information including information of the Service Discovery frame stored at the time of the device search. Then, via the sequence of FIG. 7, a WFD connection via the R2 mode is established. In this manner, in S1205, the connection process is executed from the Bootstrapping Request of S703, and in a case where time has passed from the time of the device search to when the user presses the “Connect” button or the like, the Service Discovery response frame information may not be valid. In this case, as the connection request, the Service Discovery request frame of S701 of FIG. 7 is re-transmitted, and a Service Discovery response frame from a device that supports WFD R2 selected by the user may be received. Also, on the basis of the received Service Discovery response frame, whether the device is the device selected by the user may be confirmed, and the Bootstrapping Request frame of S703 may be transmitted.

In S1206, the CPU 212 determines whether or not a WFD connection between the MFP 100 and the device selected by the user has been established. In a case where it is determined that a WFD connection has been established, the processing advances to S1207, and the CPU 212 displays a screen indicating that a WFD connection has been established. Specifically, the screen of FIG. 8I is displayed, for example. After S1207, the processing of FIG. 12 ends. On the other hand, in a case where it is determined that a WFD connection has not been established, the processing advances to S1208, and the CPU 212 displays a screen (not illustrated) indicating that a WFD connection has not been established. Thereafter, the processing of FIG. 12 ends.

As described above, according to the present embodiment, even in a case where a device that supports WFD R1 and a device that supports WFD R2 are both present in the surroundings of the MFP 100, the possibility of connecting to the device desired by the user can be increased.

Note that in the present embodiment example, the various types of control described above performed by the CPU 212 may be performed by a single piece of hardware or the processing may be shared by a plurality of pieces of hardware (for example, a plurality of processors and circuits) to perform control of the entire apparatus.

Also, preferred embodiments according to the present disclosure have been described above. However, the present disclosure is not limited to these specific embodiments and include various embodiments without departing from the scope of the claims. Furthermore, the embodiments described above are each merely embodiments of the present disclosure, and the embodiments can be combined as appropriate.

Also, in the embodiment described above, an example of the present disclosure applied to an MFP has been described. However, no such limitation is intended, and any wireless device that can perform P2P (WLAN) communication based on WFD may be used. In other words, the present disclosure is applicable to a personal computer, a PDA, a tablet terminal, a smartphone or similar mobile phone terminal, a music player, a game console, an electronic book reader, a smartwatch, and various types of measurement apparatuses (sensor apparatuses) such as a thermometer and a hygrometer. Also, the present disclosure is applicable to a digital camera (including a still camera, a video camera, a network camera, and a security camera), a printer, a scanner, and a drone. Also, the present disclosure is applicable to an image output apparatus, an audio output apparatus (for example, a smart speaker), a media streaming player, and a wireless LAN client (adapter) that can connect to a USB terminal or a LAN cable terminal. An image output apparatus includes an apparatus such as a set top box, for example, that obtains (downloads) moving image and still images from the Internet specified by a URL in an instruction from an electronic device and outputs these to a display device connected via a HDMI (registered trademark) image output terminal or the like. In this manner, streaming playback is achieved on a display device, and mirroring display (displaying content displayed on an electronic device also on a display device) is achieved. Also, the image output apparatus includes a television, hard disk recorder, Blu-ray recorder, DVD recorder, or similar media player; a head-mounted display, a projector, a television, a display apparatus (monitor), and a signage apparatus. Also, the present disclosure is applicable to a device that can connect via Wi-Fi to an air conditioner, a refrigerator, a washing machine, a vacuum cleaner, an open, an electronic microwave, a lighting fixture, a heating device, a cooling device, or any so-called smart home appliances.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-208887, filed Nov. 29, 2024 which is hereby incorporated by reference herein in its entirety.

What is claimed is:

1. An electronic device capable of communicating with an external device, the electronic device comprising:
at least one memory and at least one processor which function as:
an acceptance unit configured to accept a selection operation for selecting an operation mode from among a plurality of operation modes including a first operation mode for communication based on a Wi-Fi Direct R1 method and a second operation mode for communication based on a Wi-Fi Direct R2 method; and
a communication unit configured to execute wireless communication between the electronic device and the external device using the operation mode selected via the selection operation, without involving an external access point different from the electronic device and different from the external device.

2. The electronic device according to claim 1, wherein
the wireless communication executed using the operation mode selected via the selection operation includes communication for searching for an external device using the operation mode selected via the selection operation, and
a list screen displaying a list of information of each external device discovered via the wireless communication is displayed.

3. The electronic device according to claim 2, wherein
in a case where the first operation mode is selected, first communication for searching for an external device that supports Wi-Fi Direct is executed based on the Wi-Fi Direct R1 method, and
in a case where the second operation mode is selected, second communication for searching for an external device that supports Wi-Fi Direct is executed based on the Wi-Fi Direct R2 method.

4. The electronic device according to claim 2, further comprising:
an execution unit configured to, in a case where a piece of information is selected from the list on the list screen, execute processing for establishing a connection using Wi-Fi Direct between the electronic device and the external device corresponding to the selected piece of information.

5. The electronic device according to claim 4, wherein
in a case where a piece of information is selected from the list on the list screen displayed due to the first operation mode being selected, processing for establishing a connection using Wi-Fi Direct R1 between the electronic device and the external device corresponding to the selected piece of information is executed, and
in a case where a piece of information is selected from the list on the list screen displayed due to the second operation mode being selected, processing for establishing a connection using Wi-Fi Direct R2 between the electronic device and the external device corresponding to the selected piece of information is executed.

6. The electronic device according to claim 3, further comprising:
a display unit configured to display a screen including a region for executing the second communication, in a case where a search result is not obtained when the first communication is executed due to the first operation mode being selected; and
an execution unit configured to execute the second communication in a case where an operation is performed on the region.

7. The electronic device according to claim 6, further comprising:
a waiting unit configured to, in a case where an operation is not performed on the region, wait for a Wi-Fi Direct connection request from an external device using the operation mode selected via the selection operation.

8. The electronic device according to claim 2, wherein
the plurality of operation modes includes a third operation mode for both communication based on the Wi-Fi Direct R1 method and communication based on the Wi-Fi Direct R2 method, and
in a case where the third operation mode is selected, first communication for searching for an external device that supports Wi-Fi Direct is executed based on the Wi-Fi Direct R1 method, and second communication for searching for an external device that supports Wi-Fi Direct is executed based on the Wi-Fi Direct R2 method.

9. The electronic device according to claim 8, wherein
in a case where the first communication and the second communication are executed due to the third operation mode being selected and a search result is obtained via both the first communication and the second communication, the list includes the search result obtained via the first communication and the search result obtained via the second communication, and
in a case where a piece of information is selected from the list on the list screen displayed due to the third operation mode being selected, processing for establishing a connection between the electronic device and the external device corresponding to the selected piece of information is executed using, out of the Wi-Fi Direct R1 method and the Wi-Fi Direct R2 method, the method used to discover the external device corresponding to the selected piece of information.

10. The electronic device according to claim 9, wherein
in a case where the piece of information corresponding to the external device discovered using Wi-Fi Direct R1 is selected from the list but the electronic device is operating in a state of communicating using Wi-Fi Direct R2, control is performed such that the electronic device operates in a state of communicating using Wi-Fi Direct R1, and then processing for establishing a connection between the electronic device and the external device corresponding to the selected piece of information using Wi-Fi Direct R1 is executed.

11. The electronic device according to claim 8, wherein
the list included on the list screen displayed due to the third operation mode being selected displays information that enables identifying whether the external device was discovered based on the Wi-Fi Direct R1 method or discovered based on the Wi-Fi Direct R2 method.

12. The electronic device according to claim 8, further comprising:
a waiting unit configured to, in a case where no search result is obtained when the first communication and the second communication are executed due to the third operation mode being selected, wait for a Wi-Fi Direct connection request from an external device based on the Wi-Fi Direct R2 method.

13. The electronic device according to claim 2, further comprising:
a waiting unit configured to, while the list screen is displayed, wait for a Wi-Fi Direct connection request from an external device using the operation mode selected by the selection operation; and
an execution unit configured to, in a case where the Wi-Fi Direct connection request is received from an external device while waiting for the Wi-Fi Direct connection request from an external device, execute processing for establishing a connection using Wi-Fi Direct between the electronic device and the external device that transmitted the Wi-Fi Direct connection request.

14. The electronic device according to claim 13, wherein
while the list screen is displayed due to the first operation mode being selected, the waiting unit waits for the Wi-Fi Direct connection request from a external device based on the Wi-Fi Direct R1 method, and
while the list screen is displayed due to the second operation mode being selected, the waiting unit waits for the Wi-Fi Direct connection request from an external device based on the Wi-Fi Direct R2 method.

15. The electronic device according to claim 14, wherein
the plurality of operation modes includes a third operation mode for both communication based on the Wi-Fi Direct R1 method and communication based on the Wi-Fi Direct R2 method, and
while the list screen is displayed due to the third operation mode being selected, the waiting unit waits for the Wi-Fi Direct connection request from an external device based on the Wi-Fi Direct R2 method.

16. The electronic device according to claim 15, further comprising:
an acceptance unit configured to accept a switch operation for switching a state of the electronic device from a first state for waiting for the Wi-Fi Direct connection request from an external device based on the Wi-Fi Direct R2 method to a second state for waiting for the Wi-Fi Direct connection request from an external device based on the Wi-Fi Direct R1 method; and
a switching unit configured to switch the state of the electronic device from the first state to the second state in response to the switch operation being received.

17. The electronic device according to claim 2, wherein
the list screen includes a region for accepting a display operation for displaying a QR code including information for establishing a connection with the electronic device using Wi-Fi Direct, and
in a case where the display operation is accepted, a screen including the QR code is displayed.

18. The electronic device according to claim 1, further comprising:
a printing unit configured to execute printing.

19. A control method for an electronic device capable of communicating with an external device, comprising:
accepting a selection operation for selecting an operation mode from among a plurality of operation modes including a first operation mode for communication based on a Wi-Fi Direct R1 method and a second operation mode for communication based on a Wi-Fi Direct R2 method; and
executing wireless communication between the electronic device and the external device using the operation mode selected via the selection operation, without involving an external access point different from the electronic device and different from the external device.

20. A non-transitory computer-readable storage medium that stores one or more programs including instructions, which when executed by one or more processors of an electronic device capable of communicating with an external device, cause the electronic device to:
accepting a selection operation for selecting an operation mode from among a plurality of operation modes including a first operation mode for communication based on a Wi-Fi Direct R1 method and a second operation mode for communication based on a Wi-Fi Direct R2 method; and
execute wireless communication between the electronic device and the external device using the operation mode selected via the selection operation, without involving an external access point different from the electronic device and different from the external device.
